(19) United States
(12) Patent Application Publication
(10) Pub. No.: US 2021/0235447 A1
(43) Pub. Date: Jul. 29, 2021

(54) METHOD FOR TRANSMITTING FRAME ON BASIS OF PLURALITY OF CHANNELS IN WIRELESS LAN SYSTEM AND WIRELESS TERMINAL USING SAME

(71) Applicant: LG ELECTRONICS INC., Seoul (KR)

(72) Inventors: Saehee BANG, Seoul (KR); Jinmin KIM, Seoul (KR); Jinsoo CHOI, Seoul (KR)

(73) Assignee: LG ELECTRONICS INC., Seoul (KR)

(21) Appl. No.: 17/051,115

(22) PCT Filed: Apr. 22, 2019
(86) PCT No.: PCT/KR2019/004812

§ 371 Date: Oct. 27, 2020

(30) Foreign Application Priority Data
May 8, 2018 (KR) 10-2018-0052530
May 8, 2018 (KR) 10-2018-0052533
Jun. 14, 2018 (KR) 10-2018-0067967
Jul. 4, 2018 (KR) 10-2018-0077939

(51) Int. Cl. H04W 72/04; H04W 16/14; H04L 27/26; H04L 5/00

(52) U.S. Cl. CPC H04W 72/0453; H04W 16/14; H04W 84/12; H04L 5/0094; H04L 27/26025

(57) ABSTRACT

A method for transmitting a frame on the basis of a plurality of channels in a wireless LAN system according to an embodiment of the present invention, which is performed by a first wireless terminal, comprises the steps of: configuring a PPDU associated with a particular mode and including channel bandwidth information on the basis of first to eighth channels successively arranged on the frequency domain, wherein the PPDU associated with the particular mode is an EDMG SC mode PPDU or EDMG OFDM mode PPDU and is assigned five bits for the channel bandwidth information, and each of the first to eighth channels has a bandwidth of 2.16 GHz; and transmitting the PPDU associated with the particular mode to a second wireless terminal on the basis of the channel bandwidth.

### BACKGROUND OF THE DISCLOSURE

### Field of the Disclosure

This specification relates to wireless communication and, most particularly, to a method for transmitting a frame based on multiple channels in a wireless LAN system and a wireless device using the same.

### Related Art

Institute of Electrical and Electronics Engineers (IEEE) 802.11ad standard is an ultra-high speed wireless communication standard which is operating in a band of 60 GHz or more. The coverage range of signal is about 10 meters, but throughput of 6 Gbps or more may be supported. Since it operates in a high frequency band, a signal propagation is dominated by a ray-like propagation. A signal quality is improved as a transmit (TX) or receive (RX) antenna beam is arranged so as to head on a strong spatial signal path.

IEEE 802.11ad standard provides a beamforming training procedure for antenna beam arrangement. IEEE 802.11ay is a next generation standard which has been developed targeted to throughput of 20 Gbps or more.

### SUMMARY OF THE DISCLOSURE

### Technical Objects

An object of this specification is to provide a method for transmitting a frame based on multiple channels in a wireless LAN system having enhanced capabilities and a wireless device using the same.

### Technical Solutions

A method for transmitting a frame based on multiple channels in a wireless LAN system, which is performed by a first wireless device, according to an embodiment of the present disclosure may include the steps of configuring a Physical Protocol Data Unit (PPDU) associated with a specific mode including information on a channel bandwidth based on first to eighth channels, the first to eighth channels being sequentially arranged on a frequency, wherein the PPDU associated with/regarding the specific mode is an EDMG SC mode PPDU or EDMG OFDM mode PPDU, wherein 5 bits are allocated for the information on the channel bandwidth, and wherein each of the first to eighth channels has a bandwidth of 2.16 GHz, and transmitting the PPDU associated with/regarding the specific mode to a second wireless device based on the channel bandwidth.

### Effects of the Disclosure

According to an embodiment of this specification, provided herein is a method for transmitting a frame based on multiple channels in a wireless LAN system having enhanced capabilities and a wireless device using the same.

### BRIEF DESCRIPTION OF THE DRAWINGS

FIG. 1 is a conceptual diagram showing a structure of a wireless LAN system.

FIG. 2 is a conceptual diagram of a hierarchical architecture of a wireless LAN system supported by IEEE 802.11.

FIG. 3 is a diagram illustrating a conceptual view of an STA supporting EDCA in a wireless LAN system.

FIG. 4 is a conceptual diagram illustrating a backoff procedure according to EDCA.

FIG. 5 illustrates a frame transmission procedure in a wireless LAN (WLAN) system.

FIG. 6 is a conceptual diagram illustrating a wireless device that transmits a frame in a WLAN system according to one embodiment.

FIG. 7 illustrates multiple channels being channelized for the transmission of a frame in a wireless LAN system according to an embodiment of this specification.

FIG. 8 is a diagram showing an Enhanced Directional Multi-Gigabit (EDMG) PPDU format according to this embodiment.

FIG. 9 is a flow chart of a method for transmitting a frame based on multiple channels in a wireless LAN system according to an embodiment of this specification.

FIG. 10 is a flow chart of a method for receiving a frame based on multiple channels in a wireless LAN system according to an embodiment of this specification.

FIG. 11 is a block diagram illustrating a wireless device to which the embodiment may be applied.

FIG. 12 is a block diagram illustrating an example of a device included in a processor.

### DESCRIPTION OF EXEMPLARY EMBODIMENTS

The above-described features and detailed description below are illustrated to aid in description and understanding of the disclosure. That is, the disclosure is not limited to such embodiments and may be embodied in different forms. The following embodiments are examples for thorough disclosure and explanation for delivering the disclosure to those skilled in the art. Therefore, when there are many methods for implementing components of the disclosure, it is necessary to make it clear that the disclosure can be realized through any of a specific one of these methods and a similar one.

When a certain component includes specific elements or a certain process includes specific steps in the disclosure, other elements or other steps may be further included. That is, the terms used in the disclosure are merely for describing particular embodiments, and are not intended to limit the scope of the disclosure. Furthermore, examples described for aiding in understanding of the disclosure include complementary embodiments thereof.

All terms including technical or scientific terms have the same meanings as generally understood by a person having ordinary skill in the art to which the disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner. Hereinafter, embodiments of the disclosure will be described with reference to the attached drawings.

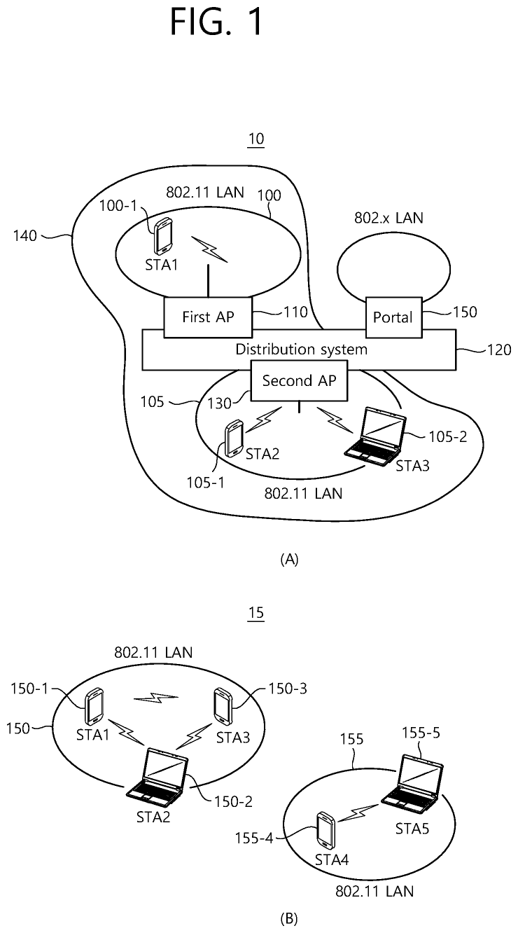

FIG. 1 is a conceptual diagram showing a structure of a wireless LAN system. FIG. 1(A) shows a structure of an infrastructure network of Institute of Electrical and Electronic engineers (IEEE) 802.11.

Referring to FIG. 1(A), the wireless system (10) shown in FIG. 1(A) may include at least one basic service set (BSS) (100, 105). A BSS is a set of an access point (AP) and a station (STA) which can communication each other in successful synchronization with each other and does not refer to a specific area.

For example, a first BSS (100) may include a first AP (110) and a single first STA (100-1). A second BSS (105) may include a second AP (130) and one or more STAs (105-1, 105-2).

The infrastructure BSSs (100, 105) may include at least one STA, APs providing a distribution service, and a distribution system (DS) (120) which connects the APs.

The distribution system (120) can realize an extended service set (ESS) (140) by connecting the plurality of BSSs (100, 105). The ESS (140) can be used as a term indicating a network realized by connecting one or more APs (110, 130) through the distribution system (120). One or more APs included in the single ESS (140) may have the same service set identifier (SSID).

A portal (150) can serve as a bridge for connecting the wireless LAN network (IEEE 802.11) to another network (e.g., 802.X).

In the wireless LAN system having the structure shown in FIG. 1(A), a network between the APs (110, 130) and a network between the APs (110, 130) and the STAs (100-1, 105-1, 105-2) can be realized.

FIG. 1(B) is a conceptual diagram showing an independent BSS. Referring to FIG. 1(B), a wireless LAN system (15) shown in FIG. 1(B) can establish a network between STAs without the APs (110, 130) such that the STAs can perform communication, distinguished from the wireless LAN system of FIG. 1(A). A network established between STAs without the APs (110, 130) for communication is defined as an ad-hoc network or an independent basic service set (IBSS).

Referring to FIG. 1(B), the IBSS (15) is a BSS operating in an ad-hoc mode. The IBSS does not have a centralized management entity because an AP is not included therein. Accordingly, STAs (150-1, 150-2, 150-3, 155-4, 155-5) are managed in a distributed manner in the IBSS (15).

All STAs (150-1, 150-2, 150-3, 155-4, 155-5) of the IBSS may be configured as mobile STAs and are not allowed to access a distributed system. All STAs of the IBSS constitutes a self-contained network.

An STA mentioned in the disclosure is an arbitrary functional medium including medium access control (MAC) conforming to regulations of Institute of Electrical and Electronics Engineers (IEEE) 802.11 and a physical layer interface with respect to a wireless medium and may be used as a meaning including both an AP and a non-AP station.

The STA mentioned in the disclosure may also be called various terms such as a mobile terminal, a wireless device, a wireless transmit/receive unit (WTRU), a user equipment (UE), a mobile station (MS), a mobile subscriber unit, and a user.

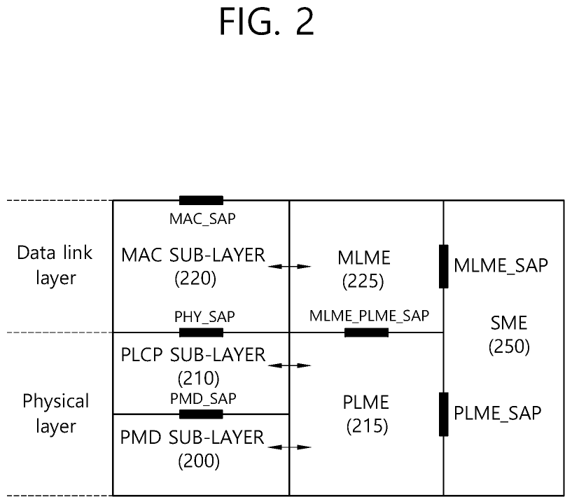

FIG. 2 is a conceptual diagram of a hierarchical architecture of a wireless LAN system supported by IEEE 802.11. Referring to FIG. 2, the hierarchical architecture of the wireless LAN system may include a physical medium dependent (PMD) sublayer (200), a physical layer convergence procedure (PLCP) sublayer (210) and a medium access control (MAC) sublayer (220).

The PMD sublayer (200) can serve as a transport interface for transmitting and receiving data between STAs. The PLCP sublayer (210) is implemented such that the MAC sublayer (220) can operate with minimum dependency on the PMD sublayer (200).

The PMD sublayer (200), the PLCP sublayer (210) and the MAC sublayer (220) may conceptually include a management entity. For example, a manager of the MAC sublayer (220) is called a MAC layer management entity (MLME) (225). A manager of the physical layer is called a PHY layer management entity (PLME) (215).

These managers can provide interfaces for performing layer management operation. For example, the PLME (215) can be connected to the MLME (225) to perform a management operation of the PLCP sublayer (210) and the PMD sublayer (200). The MLME (225) can be connected to the PLME (215) to perform a management operation of the MAC sublayer (220).

To perform correct MAC layer operation, an STA management entity (SME) (250) may be provided. The SME (250) can be operated as an independent component in each layer. The PLME (215), the MLME (225) and the SME (250) can transmit and receive information based on primitive.

The operation in each sublayer will be briefly described below. For example, the PLCP sublayer (210) transfers a MAC protocol data unit (MPDU) received from the MAC sublayer (220) to the PMD sublayer (200) or transfers a frame from the PMD sublayer (200) to the MAC sublayer (220) between the MAC sublayer (220) and the PMD sublayer (200) according to an instruction of the MAC layer.

The PMD sublayer (200) is a sublayer of PLCP and can perform data transmission and reception between STAs through a wireless medium. An MPDU transferred from the MAC sublayer (220) is referred to as a physical service data unit (PSDU) in the PLCP sublayer (210). Although the MPDU is similar to the PSDU, an individual MPDU may differ from an individual PSDU when an aggregated MPDU corresponding to an aggregation of a plurality of MPDU is transferred.

The PLCP sublayer (210) attaches an additional field including information necessary for a transceiver of the physical layer to a PSDU in a process of receiving the PSDU from the MAC sublayer (220) and transferring the PSDU to the PMD sublayer (200). Here, the attached field may be a PLCP preamble and a PLCT header attached to the PSDU, tail bits necessary to return a convolution encoder to a zero state, and the like.

The PLCP sublayer (210) attaches the aforementioned field to the PSDU to generate a PLCP protocol data unit (PPDU) and transmits the PPDU to a reception station through the PMD sublayer (200), and the reception station receives the PPDU and acquires information necessary for data restoration from the PLCP preamble and the PLCP header to restore data.

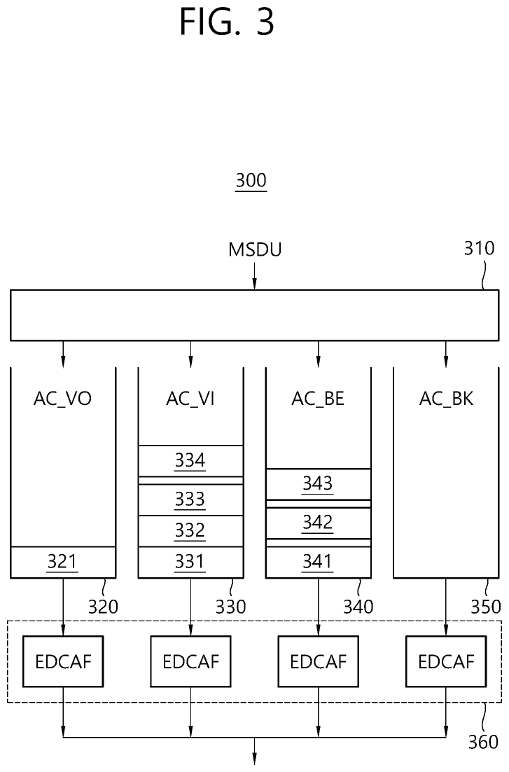

FIG. 3 is a diagram illustrating a conceptual view of an STA supporting EDCA in a wireless LAN system.

In the WLAN system, an STA (or AP) performing enhanced distributed channel access (EDCA) may perform channel access according to a plurality of user priority levels that are predefined for the traffic data.

The EDCA for the transmission of a Quality of Service (QoS) data frame based on the plurality of user priority levels may be defined as four access categories (hereinafter referred to as ‘AC’s) (background (AC_BK), best effort (AC_BE), video (AC_VI), and voice (AC_VO)).

An STA performing channel access based on the EDCA may map the traffic data, i.e., MAC service data unit (MSDU), departing from a logical link control (LLC) layer and reaching (or arriving at) a medium access control (MAC) layer, as shown below in Table 1. Table 1 is an exemplary table indicating the mapping between user priority levels and ACs.

TABLE 1

| Priority | User priority | Access category (AC) |
|---|---|---|
| Low | 1 | AC_BK |
| | 2 | AC_BK |
| | 0 | AC_BE |
| | 3 | AC_BE |
| | 4 | AC_VI |
| | 5 | AC_VI |
| | 6 | AC_VO |
| High | 7 | AC_VO |

In the present embodiment, a transmission queue and an AC parameter may be defined for each AC. The plurality of user priorities (or priority levels) may be implemented based on the AC parameter which is differently set (or configured) for each AC. When performing a backoff procedure for transmitting a frame belonging to each AC, the STA performing channel access based on the EDCA may use each of an arbitration interframe space (AIFS)[AC], a CWmin[AC], and a CWmax[AC] instead of a DCF interframe space (DIFS), a CWmin, and a CWmax, which correspond to parameters for a backoff procedure that is based on a distributed coordination function (DCF).

For reference, examples of the default values of the parameters corresponding to each AC are shown in Table 2 below.

TABLE 2

| AC | CWmin[AC] | CWmax[AC] | AIFS[AC] | TXOP limit[AC] |
|---|---|---|---|---|
| AC_BK | 31 | 1023 | 7 | 0 |
| AC_BE | 31 | 1023 | 3 | 0 |
| AC_VI | 15 | 31 | 2 | 3.008 ms |
| AC_VO | 7 | 15 | 2 | 1.504 ms |

The EDCA parameters used in the backoff procedure for each AC may be set as default value or forwarded to each STA with being carried on a beacon frame from an AP to each STA. As AIFS[AC] and CWmin[AC] values decrease, a higher priority is given, and accordingly, the channel access delay shortens, thus allowing usage of more bands in a given traffic environment. The EDCA parameter set element may include information on channel access parameters for each AC (e.g., AIFS[AC], CWmin[AC], CWmax[AC]).

In the case where a collision (or conflict) occurs between the STAs while the STA transmits a frame, an EDCA backoff procedure of generating a new backoff counter is similar to the existing DCF backoff procedure.

The differentiated backoff procedures for each AC may be performed based on different EDCA parameters. The EDCA parameters may become an important means that is used for differentiating channel access of various user priorities of traffic.

A proper configuration of the EDCA parameter value defined for each AC may increase the transport effect according to the priority of traffic while optimizing a network performance. Accordingly, an AP may perform the overall management and adjustment function for the EDCA parameters to ensure fair media accesses to all STAs that participate in the network.

In the present specification, a user priority level predefined (or preassigned) for traffic data (or traffic) may be referred to as a traffic identifier (hereinafter referred to as ‘TID’).

The transmission priority level of traffic data may be determined based on a user priority level. Referring to Table 1, the traffic identifier (TID) of traffic data having the highest user priority level may be set to ‘7’. That is, traffic data having a traffic identifier (TID) set to ‘7’ may be understood as traffic having the highest transmission priority level.

Referring to FIG. 3, one STA (or AP) (300) may include a virtual mapper (310), a plurality of transmission queues (320˜350), and a virtual collision handler (360).

The virtual mapper (310) of FIG. 3 may serve to map a MSDU received from a logical link control (LLC) layer to a transmission queue corresponding to each AC according to Table 1, which is illustrated above.

The plurality of transmission queues (320˜350) of FIG. 3 may serve as individual EDCA contention entities for channel access for a wireless medium within one STA (or AP).

For example, a transmission queue (320) of an AC_VO type of FIG. 3 may include one frame (321) for a second STA (not shown). A transmission queue (330) of an AC_VI type may include three frames (331˜333) for a first STA (not shown) and one frame (334) for a third STA (not shown) according to the order in which the frames are to be transmitted to a physical layer.

A transmission queue (340) of an AC_BE type of FIG. 3 may include one frame (341) for the second STA (not shown), one frame (342) for the third STA (not shown), and one frame (343) for the second STA (not shown) according to the order in which the frames are to be transmitted to the physical layer. A transmission queue (350) of an AC_BE type may not include a frame that is to be transmitted to the physical layer.

For example, internal backoff values for the transmission queue (320) of the AC_VO type, the transmission queue (330) of the AC_VI type, the transmission queue (340) of the AC_BE type, and the transmission queue (350) of the AC_BK type may be individually calculated based on Equation 1 below and a channel access parameter set (i.e., AIFS[AC], CWmin[AC], and CWmax[AC] in Table 2) for each AC.

The STA (300) may perform an internal backoff procedure based on an internal backoff value for each of the transmission queues (320, 330, 340, 350). In this case, a transmission queue for which the internal backoff procedure is completed first may be understood as a transmission queue corresponding to a primary AC.

A frame included in a transmission queue corresponding to the primary AC may be transmitted to another entity (e.g., another STA or AP) during a transmission opportunity (hereinafter referred to as ‘TXOP’). When there are two or more ACs for which the backoff procedure has been completed at the same time, a collision between the ACs may be coordinated according to a function (EDCA function (EDCAF)) included in the virtual collision handler (360).

That is, when a collision occurs between the ACs, a frame included in an AC having a higher priority level may be transmitted first. In addition, the other ACs may increase a contention window value and may update a value that is set (or configured) as a backoff count.

When one frame buffered in the transmission queue of the primary AC is transmitted, the STA may determine whether the STA can transmit the next frame in the same AC and can receive even the ACK of the next frame during the remaining time of the TXOP. In this case, the STA attempts to transmit the next frame after an SIFS time interval.

A TXOP limit value may be set as a default value in the AP and the STA, or a frame associated with the TXOP limit value may be transmitted to the STA from the AP. When the size of a data frame that is to be transmitted exceeds the TXOP limit value, the STA may fragment the frame into a plurality of smaller frames. Subsequently, the fragmented frames may be transmitted within a range that does not exceed the TXOP limit value.

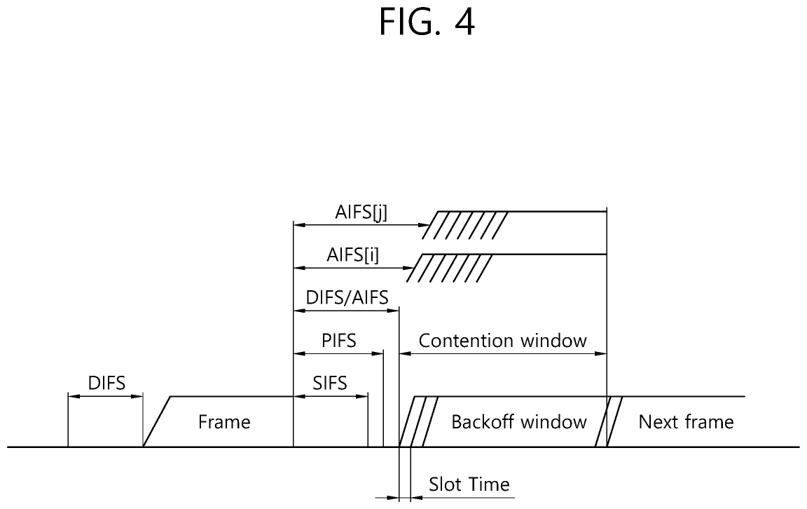

FIG. 4 is a conceptual diagram illustrating a backoff procedure according to EDCA.

STAs may share a wireless medium based on a distributed coordination function (hereinafter referred to as ‘DCF’). The DCF is an access protocol for controlling a collision between STAs and may use a carrier sense multiple access/collision avoidance (hereinafter referred to as ‘CSMA/CA’).

When it is determined that the wireless medium is not used during a DCF interframe space (DIFS) (i.e., when the wireless medium is idle) by the DCF, an STA may obtain a right (or authority) to transmit an MPDU that is internally determined through the wireless medium. For example, the internally determined MPDU may be understood as the frame included in the transmission queue of the primary AC illustrated in FIG. 3.

When it is determined that the wireless medium is used by another STA during the DIFS (i.e., when the wireless medium is busy) by the DCF, the STA may wait until the wireless medium is idle in order to obtain a right to transmit the MPDU that is internally determined through the wireless medium.

Subsequently, the STA may defer channel access for the DIFS from the time at which the wireless medium is switched to the idle state. Then, the STA may wait for as long as a contention window (hereinafter referred to as ‘CW’) set in a backoff counter.

In order to perform the backoff procedure according to EDCA, each STA may set a backoff value, which is arbitrarily selected within the contention window (CW), in the backoff counter. For example, the backoff value set in the backoff counter of each STA in order to perform the backoff procedure according to EDCA may be associated with an internal backoff value, which is used in an internal backoff procedure to determine the primary AC for each STA.

In addition, the backoff value set in the backoff counter of each STA may be a value newly set in the backoff counter of each STA for a transmission queue of the primary AC for each STA based on Equation 1 below and a channel access parameter set for each AC (i.e., AIFS[AC], CWmin[AC], and CWmax[AC] in Table 2).

In this specification, time expressing a backoff value, which is selected by each STA, in slot time units may be interpreted and understood as the backoff window of FIG. 4.

Each STA may perform a countdown of reducing the backoff window set in the backoff counter by slot time unit. Among the plurality of STAs, an STA having the relatively shortest backoff window configuration may obtain a transmission opportunity (hereinafter referred to as ‘TXOP’), which is a right to occupy a wireless medium.

During a time period for the TXOP, the remaining STAs may suspend the countdown. The remaining STAs may wait until the time period for the TXOP expires. After the time period for the TXOP expires, the remaining STAs may resume the suspended countdown operation in order to occupy the wireless medium.

According to the transmission method based on the DCF, it is possible to prevent collision between STAs, which may occur when a plurality of STAs transmits frames at the same time. However, the channel access method using the DCF does not have the concept of transmission priority level (i.e., user priority level). That is, using the DCF does not guarantee (or ensure) the quality of service (QoS) of traffic to be transmitted by the STA.

In order to resolve this problem, a hybrid coordination function (hereinafter referred to as ‘HCF’), which is a new coordination function, is defined in 802.11e. The newly defined HCF has more enhanced performance than that of the existing channel access performance using the DCF. To enhance the QoS, the HCF may use two different types of channel access methods together, which are HCF-controlled channel access (HCCA) of a polling method and contention-based enhanced distributed channel access (EDCA).

Referring to FIG. 4, it may be assumed that the STA attempts to transmit buffered traffic data. User priority levels set for each traffic data may be differentiated as shown in Table 1. The STA may include four types (AC_BK, AC_BE, AC_VI, and AC_VO) of output queues mapped to the user priority levels illustrated in Table 1.

The STA may transmit traffic data based on an arbitration interframe space (AIFS) instead of the existing DCF interframe space (DIFS).

Hereinafter, in embodiments of the present disclosure, a wireless device (or terminal) (i.e., STA) may be a device that is capable of supporting both a WLAN system and a cellular system. That is, the wireless device may be construed (or interpreted) as a UE supporting the cellular system or an STA supporting the WLAN system.

To facilitate the understanding of this specification, interframe spacing, which is mentioned in 802.11, will be described. For example, interframe spacing (IFS) may be a reduced interframe space (RIFS), a short interframe space (SIFS), a PCF interframe space (PIFS), a DCF interframe space (DIFS), an arbitration interframe space (AIFS), or an extended interframe space (EIFS).

The interframe spacing (IFS) may be determined depending on attributes specified by the physical layer of the STA regardless of the bit rate of the STA. Among the IFSs, IFSs other than the AIFS may be understood as a fixed value for each physical layer.

The AIFS may be set to a value corresponding to the four types of transmission queues mapped to the user priority levels illustrated in Table 2.

The SIFS has the shortest time gap among the IFSs mentioned above. Accordingly, the SIFS may be used when an STA occupying a wireless medium needs to maintain the occupation of the medium without any interruption by another STA during a period in which a frame exchange sequence is performed.

That is, by using the shortest gap between transmissions within a frame exchange sequence, the STA may be assigned with a priority level to complete an ongoing frame exchange sequence. Also, the STA accessing the wireless medium by using the SIFS may immediately start transmission from the boundary of the SIFS without determining whether or not the medium is busy.

The duration of an SIFS for a specific physical (PHY) layer may be defined based on aSIFSTime parameter. For example, the SIFS has a value of 16 μs in physical (PHY) layers according to IEEE 802.11a, IEEE 802.11g, IEEE 802.11n, and IEEE 802.11ac standards.

The PIFS may be used in order to provide an STA with the next highest priority level after the SIFS. That is, the PIFS may be used to obtain priority for accessing the wireless medium.

The DIFS may be used by an STA transmitting a data frame (MPDU) and a management frame (MAC protocol data unit (MPDU)) based on the DCF. After a received frame and backoff time expire, when it is determined that the medium is idle by a carrier sense (CS) mechanism, the STA may transmit a frame.

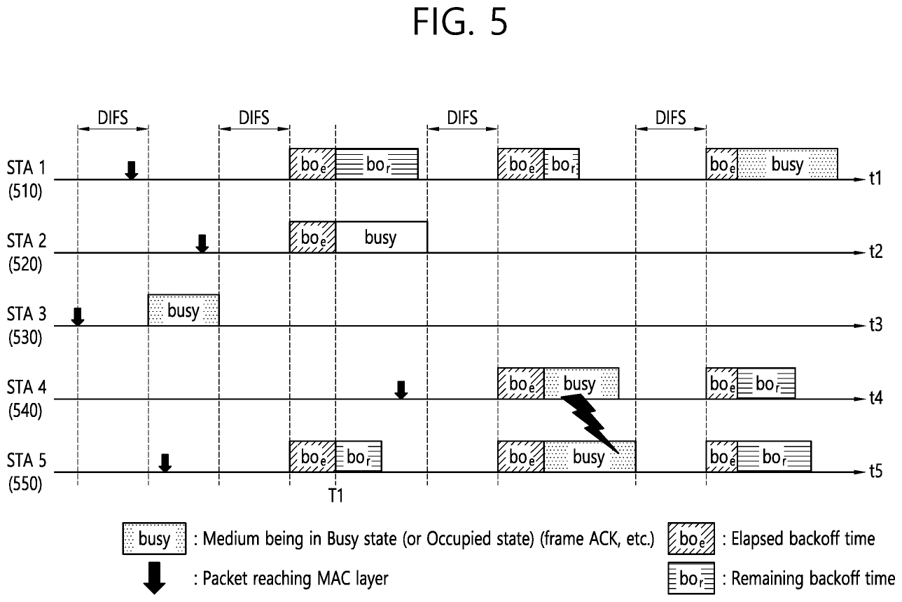

FIG. 5 illustrates a frame transmission procedure in a wireless LAN (WLAN) system.

Referring to FIG. 4 and FIG. 5, each STA (510, 520, 530, 540, 550) in the WLAN system may individually set a backoff value in a backoff counter for each of the STAs (510, 520, 530, 540, 550) in order to perform a backoff procedure according to EDCA.

Each of the STAs (510, 520, 530, 540, 550) may attempt to perform transmission after waiting for a time period (i.e., the backoff window in FIG. 4) indicating the set backoff value in slot time units.

Further, each of the STAs (510, 520, 530, 540, 550) may reduce the backoff window by slot time units through a countdown operation. The countdown operation for channel access for the wireless medium may be individually performed by each STA.

Each STA may individually set random backoff time (Tb[i]) corresponding to the backoff window in the backoff counter for each STA. Specifically, the backoff time (Tb[i]) is a pseudo-random integer value and may be calculated based on Equation 1 shown below.

T_{b}[i]=Random(i)×SlotTime [Equation 1]

Random(i) in Equation 1 denotes a function using uniform distribution and generating a random integer between 0 and CW[i]. CW[i] may be understood as a contention window that is selected between a minimum contention window (CWmin[i]) and a maximum contention window (CWmax[i]).

For example, the minimum contention window (CWmin[i]) and the maximum contention window (CWmax[i]) may respectively correspond to CWmin[AC] and CWmax[AC], which are default values shown in Table 2.

For initial channel access, the STA may select a random integer between 0 and CWmin[i], with CW[i] set to CWmin[i]. In this case, the selected random integer may be referred to as a backoff value.

In Equation 1, i may be understood as corresponding to a user priority level of Table 1. That is, traffic buffered for the STA may be understood as corresponding to any one of AC_VO, AC_VI, AC_BE, and AC_BK of Table 1 based on a value set for i in Equation 1.

SlotTime in Equation 1 may be used to provide sufficient time for a preamble of the transmitting STA to be detected by a neighbor STA. SlotTime in Equation 1 may be used to define the aforementioned PIFS and DIFS. For example, SlotTime may be equal to 9 μs.

For example, when the user priority level (i) is ‘7’, an initial backoff time (Tb[7]) for a transmission queue of the AC_VO type may be a time indicating a backoff value, which is selected between 0 and CWmin[AC_VO], in SlotTime units.

When a collision occurs between STAs according to the backoff procedure (or when an ACK frame of a transmitted frame is not received), the STA may newly calculate increased backoff time (Tb[i]′) based on Equation 2 shown below.

CW_{new}[ii]=((CW_{old}[i]+1)×PF)−1 [Equation 2]

Referring to Equation 2, a new contention window (CWnew[i]) may be calculated based on a previous contention window (CWold[i]). A PF value of Equation 2 may be calculated in accordance with a procedure defined in the IEEE 802.11e standard. For example, the PF value of Equation 2 may be set to ‘2’.

In the present embodiment, the increased backoff time (Tb[i]′) may be understood as a time indicating a random integer (i.e., backoff value), which is selected between 0 and the new contention window (CWnew[i]), in SlotTime units.

CWmin[i], CWmax[i], AIFS[i], and PF values mentioned in FIG. 5 may be signaled from an AP through a QoS parameter set element, which is a management frame. The CWmin[i], CWmax[i], AIFS[i], and PF values may be values that are predetermined (or preset) by the AP and the STA.

Referring to FIG. 5, the horizontal axis (t1 to t5) for first to fifth STAs (510˜550) may indicate a time axis. The vertical axis for the first to fifth STAs (510˜550) may indicate transmitted backoff time.

Referring to FIG. 4 and FIG. 5, if a particular medium is changed from an occupied or busy state to an idle state, the plurality of STAs may attempt to transmit data (or a frame).

At this point, as a solution for minimizing collision between STAs, each STA may select a backoff time (Tb[i]) of Equation 1 and may attempt to perform transmission after waiting for a SlotTime corresponding to the selected backoff time.

When a backoff procedure is initiated, each STA may count down an individually selected backoff counter time by SlotTime units. Each STA may continuously monitor the medium while performing the countdown.

When the wireless medium is determined to be occupied, the STAs may suspend the countdown and may wait (i.e., be on stand-by). When the wireless medium is determined to be idle, the STAs may resume the countdown.

Referring to FIG. 5, when a frame for the third STA (530) reaches the MAC layer of the third STA (530), the third STA (530) may determine whether the medium is idle during a DIFS. When it is determined that the medium is idle during the DIFS, the third STA (530) may transmit the frame to the AP (not shown). Herein, however, although FIG. 5 illustrates the DIFS as an interframe space (IFS), it should be noted that this specification will not be limited only to this.

While the frame is transmitted from the third STA (530), the remaining STAs may check the occupancy state of the medium and may stand-by (or wait) during the transmission period of the frame. A frame may reach the MAC layer of each of the first STA (510), the second STA (520), and the fifth STA (550). When it is determined that the medium is idle, each STA may wait for as long as a DIFS and may then count down backoff time being individually selected by each STA.

FIG. 5 shows that the second STA (520) selects the shortest backoff time and the first STA (510) selects the longest backoff time. FIG. 5 shows that the remaining backoff time for the fifth STA (550) is shorter than the remaining backoff time for the first STA (510) at the time (T1) when a backoff procedure for the backoff time selected by the second STA (520) is completed and the transmission of a frame starts.

When the medium is occupied by the second STA (520), the first STA (510) and the fifth STA (550) may suspend the backoff procedure and may wait (i.e., be on stand-by). When the second STA (520) finishes occupying the medium (i.e., when the medium returns to the idle state), the first STA (510) and the fifth STA (550) may wait for as long as a DIFS.

Subsequently, the first STA (510) and the fifth STA (550) may resume the backoff procedure based on the suspended remaining backoff time. In this case, since the remaining backoff time for the fifth STA (550) is shorter than the remaining backoff time for the first STA (510), the fifth STA (550) may complete the backoff procedure before the first STA (510).

Meanwhile, referring to FIG. 5, when the medium is occupied by the second STA (520), a frame for the fourth STA (540) may reach the MAC layer of the fourth STA (540). When the medium is idle, the fourth STA (540) may wait for as long as a DIFS. Subsequently, the fourth STA (540) may count down the backoff time selected by the fourth STA (540).

Referring to FIG. 5, the remaining backoff time for the fifth STA (550) may coincidently match the remaining backoff time for the fourth STA (540). In this case, a collision may occur between the fourth STA (540) and the fifth STA (550). If the collision occurs between the STAs, both the fourth STA (540) and the fifth STA (550) may not receive an ACK and may fail to transmit data.

Accordingly, the fourth STA (540) and the fifth STA (550) may individually calculate a new contention window (CWnew[i]) according to Equation 2. Subsequently, the fourth STA (540) and the fifth STA (550) may individually count down backoff time newly calculated according to Equation 2.

When then medium is in the occupied state due to transmission by the fourth STA (540) and the fifth STA (550), the first STA (510) may wait (i.e., be on stand-by). Subsequently, when the medium is in the idle state, the first STA (510) may wait for the DIFS and may then resume backoff counting. After the remaining backoff time for the first STA (510) elapses, the first STA (510) may transmit a frame.

The CSMA/CA mechanism may include virtual carrier sensing in addition to physical carrier sensing in which an AP and/or STA directly senses a medium.

Virtual carrier sensing is used to compensate for any any problem that may occur during access to a medium, such as a hidden node problem. For virtual carrier sensing, the MAC of a WLAN system uses a network allocation vector (NAV). The NAV is a value representing a time remaining for a medium to be available, which is indicated by an AP and/or STA currently using the medium or having the right (or authority) to use the medium to another AP and/or STA.

Therefore, a value set as the NAV corresponds to a period in which an AP and/or STA transmitting a frame is scheduled to use a medium, and an STA receiving the NAV value is prohibited from accessing the medium during the corresponding period. The NAV may be set, for example, according to the value of a duration field in a MAC header of the frame.

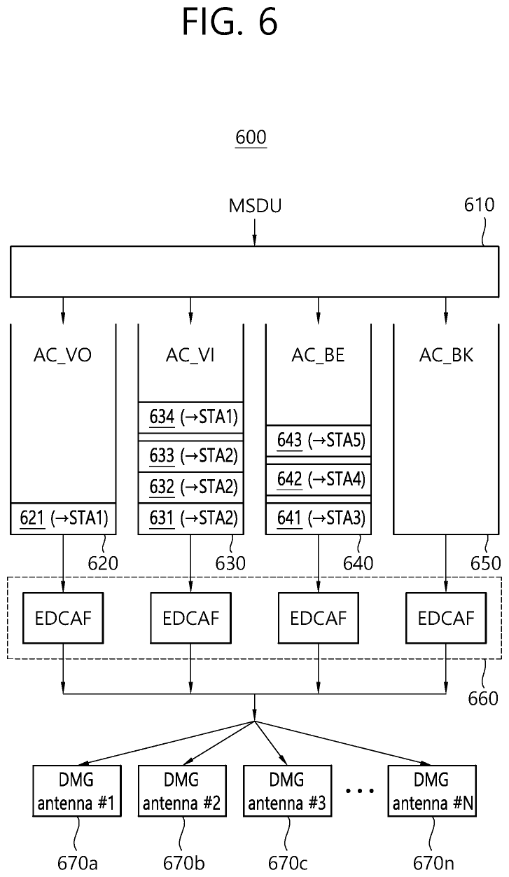

FIG. 6 is a conceptual diagram illustrating a wireless device that transmits a frame in a WLAN system according to one embodiment.

Referring to FIG. 6, the wireless device (600) according to the present embodiment may include a virtual mapper (610), a plurality of transmission queues (620˜650), a virtual collision handler (660), and a plurality of directional antenna modules (670a˜670n).

Referring to FIG. 1 to FIG. 6, descriptions of the virtual mapper (610), the plurality of transmission queues (620˜650), and the virtual collision handler (660) in FIG. 6 may be understood by referring to the descriptions of the virtual mapper (310), the plurality of transmission queues (320˜350), and the virtual collision handler (360) in FIG. 3.

According to the embodiment of FIG. 6, the wireless device (600) may have an internal structure in which one set of transmission queues (620, 630, 640, 650) in the wireless device is associated with the plurality of directional antenna modules (670a˜670n).

A directional multi-gigabit (DMG) antenna according to the present embodiment may include a plurality of physical antennas. Further, the DMG antenna according to the present embodiment may be understood as a set of a plurality of physical (or logical) antennas arranged (or aligned) in one direction.

For the clear and specific description of the present specification, a first directional antenna module (670a) may include a first DMG antenna associated with a first user device (not shown), and a second directional antenna module (670b) may include a second DMG antenna associated with a second user device (not shown).

Further, a third directional antenna module (670c) may include a third DMG antenna associated with a third user device (not shown), and an Nth directional antenna module (670n) (wherein n is a natural number) may include an Nth DMG antenna associated with an Nth STA (e.g., N is a natural number).

Hereinafter, it is assumed that the wireless device (600) of FIG. 6 includes five directional antenna modules (670a˜670e). The wireless device (600) of FIG. 6 may associate a plurality of data frames (621, 631˜634, 641˜643) with the plurality of directional antenna modules (670a˜670n) based on Receive Address (hereinafter referred to as ‘RA’) information being configured for each of the plurality of data frames (621, 631˜634, 641˜643).

A first data frame (621) may be buffered in a transmission queue (620) of the AC_VO type. For example, the first data frame (621) may be understood as an MPDU including RA information indicating the first user device (not shown).

Second to fifth data frames (631˜634) may be buffered in a transmission queue (630) of the AC_VI type. For example, the second to fourth data frames (631, 632, 633) may be understood as MPDUs including Receive Address (RA) information indicating the second user device (not shown). For example, the fifth data frame (634) may be understood as an MPDU including RA information indicating the first user device (not shown).

Sixth to eighth data frames (641˜643) may be buffered in a transmission queue (640) of the AC_BE type. For example, the sixth data frame (641) may be understood as an MPDU including RA information indicating the third user device (not shown).

For example, the seventh data frame (642) may be understood as an MPDU including RA information indicating a fourth user device (not shown). For example, the eighth data frame (643) may be understood as an MPDU including Receive Address (RA) information indicating a fifth user device (not shown).

It should be noted that the plurality of data frames included in the transmission queues illustrated in FIG. 6 are merely exemplary, and that the present specification will not be limited to this.

Each directional antenna module (670a˜670n) according to the exemplary embodiment of this specification may receive data frames being buffered to a plurality of transmission queues in accordance with the Receive Address (RA) information that is included in the corresponding data frames.

For example, a first data frame (621) and a fifth data frame (634) may be transmitted through a first directional antenna module (670a) may receive. And, second to fourth data frames (631, 632, 633) may be transmitted through a second directional antenna module (670b).

A sixth data frame (641) may be transmitted through a third directional antenna module (670c). A seventh data frame (642) may be transmitted through a fourth directional antenna module (670d). And, an eighth data frame (643) may be transmitted through a fifth directional antenna module (670e).

A legacy wireless device may perform an omnidirectional clear channel assessment (CCA) procedure. More specifically, the legacy STA may determine a state of a wireless medium by comparing a power level of a signal, which is received from a physical layer of a wireless device during a predetermined time (e.g., DIFS) according to an omnidirectional method, and a predetermined threshold level.

For example, in case the power level of the signal being received from the physical layer is lower than the threshold level, the status of the wireless medium may be determined to be an idle state. In case the power level of the signal being received from the physical layer is higher than the threshold level, the status of the wireless medium status may be determined to be a busy state.

The wireless device (600) according to the present embodiment may cover multiple directions being associated with the plurality of directional antenna modules (670a˜670n) in accordance with a directional method. More specifically, the wireless device (600) may perform an individual directional CCA procedure for multiple radio channels corresponding to the multiple directions during a predetermined time.

That is, the wireless device (600) may individually (or separately) determine the state of the multiple radio channels being associated with the plurality of directional antenna modules (670a˜670n) for multiple user devices (not shown).

Hereinafter, the CCA operation being simultaneously performed for the multiple directions by the wireless device according to the embodiment of this specification may be referred to as directional clear channel assessment (CCA) procedure.

The plurality of directional antenna modules (670a˜670n) according to the embodiment of this specification may be respectively associated with the channels of specific directions for each user device (not shown).

The wireless device according to the embodiment of this specification may simultaneously perform multiple separate directional CCA procedures according to a direction method. That is, a first radio channel may be determined to be in a busy state through a first directional CCA procedure for a first direction, among the multiple directions, and a second radio channel may be determined to be in an idle state through a second directions CCA procedure for a second direction.

Similarly, an Nth radio channel of an Nth direction for an Nth user device (not shown) may be determined to be in an idle state (or busy state) through a directional CCA procedure.

The wireless device according to the embodiment of this specification may transmit data (or a data frame) being included in a transmission queue of a primary AC based on at least one directional antenna module being associated with at least one radio channel that is determined to be in an idle state.

Additionally, the wireless device according to the embodiment of this specification may transmit a data frame being included in a transmission queue of a primary AC and data (or a data frame) being included in a transmission queue of a secondary AC based on at least one directional antenna module being associated with at least one radio channel that is determined to be in an idle state.

Additionally, although it is not mentioned in the description associated with FIG. 6, the plurality of directional antenna modules (670a˜670n) may be used for receiving radio signals (or wireless signals) being transmitted from another wireless device.

Additionally, an internal structure of the wireless device shown in FIG. 6 is merely exemplary. And, therefore, it shall be understood that the wireless device according to this specification may be implemented based on a structure wherein a set of the plurality of transmission queues corresponds to the plurality of antenna modules.

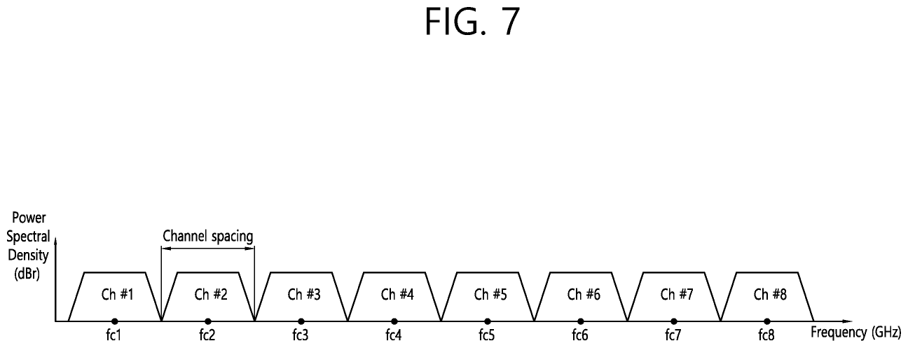

FIG. 7 illustrates multiple channels being channelized for the transmission of a frame in a wireless LAN system according to an embodiment of this specification.

An x-axis of FIG. 7 may indicate a frequency (GHz) for a 60 GHz band. A y-axis of FIG. 7 may indicate a level (dBr) of a relative signal for a maximum spectral density.

Referring to FIG. 7, in order to support transmitting and receiving operations of a wireless device according to this embodiment in a 60 GHz band, first channel to eight channel (ch #1˜ch #8) may be sequentially allocated on the frequency. For example, channel spacing for each of the first channel to eight channel (ch #1˜ch #8) may be 2,160 MHz.

A channel center frequency for each of the first channel to eight channel (ch #1˜ch #8) according to this embodiment may be defined based on Equation 3 shown below. For example, the channel starting frequency may be 56.16 GHz.

channel center fequency=channel starting frequency+channel spacing×channel number [Equation 3]

According to Equation 3, a first channel center frequency (fc1) for a first channel (ch #1) may be 58.32 GHz. For example, the first channel (ch #1) of FIG. 7 may be defined between 57.24 GHz and 59.40 GHz.

According to Equation 3, a second channel center frequency (fc2) for a second channel (ch #2) may be 60.48 GHz. For example, the second channel (ch #2) of FIG. 7 may be defined between 59.40 GHz and 61.56 GHz.

According to Equation 3, a third channel center frequency (fc3) for a third channel (ch #3) may be 62.64 GHz. For example, the third channel (ch #3) of FIG. 7 may be defined between 61.56 GHz and 63.72 GHz.

According to Equation 3, a fourth channel center frequency (fc4) for a fourth channel (ch #4) may be 64.80 GHz. For example, the fourth channel (ch #4) of FIG. 7 may be defined between 63.72 GHz and 65.88 GHz.

According to Equation 3, a fifth channel center frequency (fc5) for a fifth channel (ch #5) may be 66.96 GHz. For example, the fifth channel (ch #5) of FIG. 7 may be defined between 65.88 GHz and 68.04 GHz.

According to Equation 3, a sixth channel center frequency (fc6) for a sixth channel (ch #6) may be 69.12 GHz. For example, the sixth channel (ch #6) of FIG. 7 may be defined between 68.04 GHz and 70.2 GHz.

According to Equation 3, a seventh channel center frequency (fc7) for a seventh channel (ch #7) may be 71.28 GHz. For example, the seventh channel (ch #7) of FIG. 7 may be defined between 70.20 GHz and 72.36 GHz.

According to Equation 3, an eighth channel center frequency (fc8) for an eighth channel (ch #8) may be 73.44 GHz. For example, the eighth channel (ch #8) of FIG. 7 may be defined between 72.36 GHz and 74.52 GHz.

Detailed description on channelization and channel numbering, which are mentioned in this specification, are described in more detail in Section 19.3.15 of IEEE Draft P802.11-REVmc™/D8.0, which was disclosed in August, 2016, and in Section 21.3.1, Section 21.3.2, and Annex E of IEEE Std 802.11ad™, which was disclosed on December, 2012.

For example, a wireless device according to this specification may transmit a frame based on a radio channel being allocated for each of the plurality of antenna modules (670a˜670n) aforementioned in FIG. 6.

Additionally, the radio channel being mentioned in this specification may be understood as a multi-channel applying a channel bonding scheme or a channel aggregation scheme for the multiple channels (Ch #1˜Ch #8) of FIG. 7.

Hereinafter, a procedure for signaling bandwidth information for a radio channel applying channel bonding and/or channel aggregation in order to maximize the performance gain of the wireless LAN (WLAN) system will be described in detail.

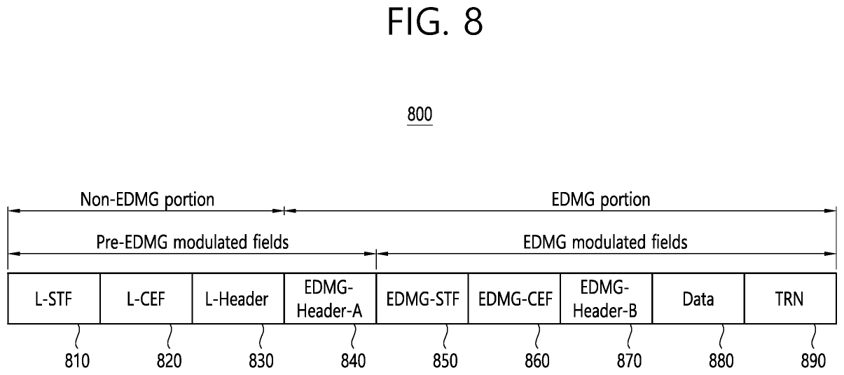

FIG. 8 is a diagram showing an Enhanced Directional Multi-Gigabit (EDMG) PPDU format according to this embodiment. Referring to FIG. 1 to FIG. 8, an EDMG PPDU format according to an IEEE 802.11ay standard document is illustrated in FIG. 8.

Referring to FIG. 8, an EDMG PPDU (800) may include multiple fields (810˜890). Hereinafter, it may be assumed that the wireless device according to this specification is in an EDMG SC mode (or EDMG Orthogonal Frequency Division Multiplexing (OFDM) mode).

According to this embodiment, the wireless device being in the EDMG SC mode (or EDMG OFDM mode) may transmit a frame that is based on the EDMG SC mode (or EDMG OFDM mode) (i.e., EDMG SC PPDU or EDMG OFDM PPDU).

According to this embodiment, the EDMG PPDU (800) that is transmitted by the wireless device being in the EDMG SC mode (or EDMG OFDM mode) may be referred to as an EDMG Single Carrier mode PPDU (EDMG SC mode PPDU) or EDMG OFDM mode PPDU.

The EDMG SC mode PPDU or EDMG OFDM mode PPDU (800) may include L-STF field (810), L-CEF field (820), and L-Header field (830), which correspond to a non-EDMG portion.

For example, all or part of the non-EDMG portion (810, 820, 830) of the EDMG SC mode PPDU or EDMG OFDM mode PPDU (800) may be transmitted based on multiple channels (e.g., Ch #1˜Ch #8 of FIG. 7).

Additionally, the EDMG SC mode PPDU or EDMG OFDM mode PPDU (800) may include EDMG Header-A field (840), Data field (880), and TRN field (890), which correspond to an EDMG portion.

The L-STF field (810), which is included in the EDMG SC mode PPDU or EDMG OFDM mode PPDU (800), may be understood as a field for packet detection.

The L-CEF field (820), which is included in the EDMG SC mode PPDU or EDMG OFDM mode PPDU (800), may be understood as a field for channel estimation.

The L-Header field (830), which is included in the EDMG SC mode PPDU or EDMG OFDM mode PPDU (800), may be configured of multiple fields, as shown below in Table 3 and Table 4.

TABLE 3

| | Number | Start | |
|---|---|---|---|
| Field name | of bits | bit | Description |
| Scrambler | 7 | 0 | Bits X1-X7 of the initial scrambler state. |
| Initialization | | | |
| Base MCS | 5 | 7 | Modulation and Coding Scheme (see |
| | | | Table 20-19) |
| Length | 18 | 12 | If the Extended SC MCS Indicaiton |
| | | | field is 0, indicates the number of data |
| | | | octets in the PSDU; range 1-262 143. |
| | | | If the Extended SC MCS Indication field |
| | | | is 1, the Length field value is set to |
| | | | Base_Length1 − └(Base_Length2 − |
| | | | N)/4 ┘, where Nis the number of data |
| | | | octets in the PSDU, and Base_Length1 |
| | | | and Base_Length2 are computer |
| | | | according to Table 20-18. The number |
| | | | of data octets in the PSDU shall not |
| | | | exceed 262 143 |
| Additional | 1 | 30 | Contains a copy of the parameter ADD- |
| PPDU | | | PPDU from the TXVECTOR. A value of |
| | | | 1 indicates that tis PPDU is immediately |
| | | | followed by another PPDU with no IFS |
| | | | or preamble on the subsequent PPDU. A |
| | | | value of 0 indicates that no additional |
| | | | PPDU follows this PPDU. |
| Packet Type | 1 | 31 | Corresponds to the TXVECTOR |
| | | | parameter PACKET-TYPE. |
| | | | Packet Type = 0 (BRP-RX packet, see |
| | | | 20.10.2.2.3), indicated either a PPDU |
| | | | whose data part is folloed by one or |
| | | | more TRN subfields (when the Beam |
| | | | Tracking Request field is 0 or in DMG |
| | | | control mode), or a PPDU that contains |
| | | | a request for TRN subfields to be |
| | | | appended to a future response PPDU |
| | | | (when the Beam Tracking Request field |
| | | | is 1). |
| | | | Packet Type = 1 (CRP-TX packet, see |
| | | | 20.10.2.2.3), indicates a PPDU whose |
| | | | data part is followed by one or more |
| | | | TRN subfields. The transmitter may |
| | | | change AWV at the beginning of each |
| | | | TRN subfield. |
| | | | The field is reserved when the Training |
| | | | Length field is 0. |

TABLE 4

| | Number | Start | |
|---|---|---|---|
| Field name | of bits | bit | Description |
| Training | 5 | 32 | Corresponds to the TXVECTOR |
| Length | | | parameter TRN-LEN. |
| | | | If the Beam Tracking Request field is |
| | | | 0, the Training Length field indicates |
| | | | the length of the training field. The |
| | | | use of this field is defined in |
| | | | 20.10.2.2.3. A value of 0 indicates |
| | | | that no training field is present in |
| | | | this PPDU. |
| | | | If the Beam Tracking Request field is |
| | | | 1 and the Packet Type field is 1, the |
| | | | Training Length field indicates the |
| | | | length of the training field appended |
| | | | to this PPDU. If the Packet Type field |
| | | | is 0, the Training Length field |
| | | | indicates the length of the training |
| | | | field requested for receive training. |
| Aggregation | 1 | 37 | Set to 1 to indicate that the PPDU in |
| | | | the data portion of the packet contains |
| | | | an A-MPDU; otherwise, set to 0. |
| Beam Tracking | 1 | 38 | Corresponds to the TXVECTOR |
| Request | | | parameter BEAM_TRACKING_ |
| | | | REQUEST. |
| | | | Set to 1 to indicated the need for |
| | | | beam tracking (10.38.7); otherwise, |
| | | | set to 0. |
| | | | The Beam Tracking Request field is |
| | | | reserved when the Training Length |
| | | | field is 0. |
| Last RSSI | 4 | 39 | Contains a copy of the parameter |
| | | | LAST_RSSI from the TXVECTOR. |
| | | | The value is an unsigned integer: |
| | | | Values 2 to 14 represent power levels |
| | | | (−71 + value × 2) dBm. |
| | | | A value of 15 represents a power |
| | | | greater than or equal to −42 dBm. |
| | | | A value of 1 represents a power less |
| | | | than or equal to −68 dBm. |
| | | | A value of 0 indicates that the |
| | | | previous packet was not received a |
| | | | SIFS before the current transmission. |
| Turnaround | 1 | 43 | As defined in Table 20-1. |
| Extended SC | 1 | 44 | The Extended SC MCS Indication |
| MCS Indication | | | field combined with the Base MCS |
| | | | field indicated the MCS. |
| | | | The Extended SC MCS Indication |
| | | | field indicates whether the Length |
| | | | field shall be calculated according to |
| | | | Table 20-18. |
| Reserved | 3 | 45 | |
| HCS | 16 | 48 | Header check sequence |

According to this embodiment, in order to imply that the corresponding PPDU is an EDMG PPDU, the reserved bit Number 46 (reserved bit 46) of Table 4 may be set to ‘1’. Additionally, when the reserved bit Number 46 (reserved bit 46) of Table 4 is set to ‘1’, the presence of the EDMG-Header-A field may be indicated.

According to this embodiment, 5 LSB bits of the Length field shown in Table 3 may be redefined as a Compressed BW field, as shown below in Table 5.

TABLE 5

| Bit | | |
|---|---|---|
| number | Field name | Definition |
| B0-B4 | Compressed | The Compressed BW field indicates the |
| | BW | bandwidth over which the PPDU is transmitted. |

Referring to Table 5, when the 5 LSB bits of the Length field of Table 3 is redefined as a Compressed BW field, as presented above in Table 5, the Compressed BW field may indicate a bandwidth over which the corresponding PPDU (i.e., EDMG SC mode PPDU or EDMG OFDM mode PPDU) is transmitted. In this case, values that are not defined in the Compressed BW field for indicating the bandwidth may be understood as reserved values. Referring to FIG. 7 and FIG. 8, when the channel bonding scheme is applied for the multi-channels for the wireless device, among the first to eighth channels (ch #˜ch #8), multiple adjacent channels within the frequency may be used.

Additionally, when the channel aggregation scheme is applied for the multi-channels for the wireless device, among the first to eighth channels (ch #˜ch #8), multiple separated channels within the frequency may be used.

By using the Compressed BW field of Table 3, bandwidth information of a wireless channel that can be combined in accordance with the channel bonding scheme or the channel aggregation scheme may be signaled to the receiving device (or UE).

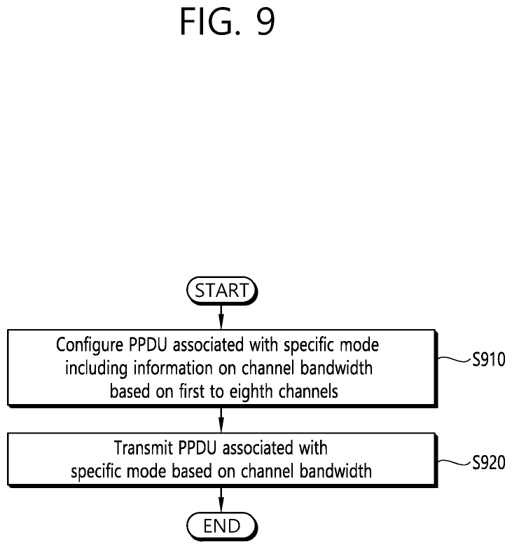

Based on the total of 5 bits (i.e., Compressed BW field), the process of signaling the bandwidth information of a wireless channel that can be combined in accordance with the channel bonding scheme or the channel aggregation scheme will be described in more detail with reference to FIG. 9.

The data field (880), which is included in the EDMG SC mode PPDU or EDMG OFDM mode PPDU (800), may carry (or deliver) a PSDU. The PSDU being included in the Data field (880) may correspond to a payload.

The Training Sequence (TRN) field (890), which is included in the EDMG SC mode PPDU or EDMG OFDM mode PPDU (800), may include information enabling transmit and receive Antenna Weight Vector training by multiple STAs.

FIG. 9 is a flow chart of a method for transmitting a frame based on multiple channels in a wireless LAN system according to an embodiment of this specification.

Referring to FIG. 1 to FIG. 9, in step S910, a first wireless device may configure a PPDU being associated with a specific mode including encoding information for a channel bandwidth that is configured based on first to eighth channels, which are sequentially arranged on the frequency based on channelization. Herein, the PPDU being associated with a specific mode may denote an EDMG SC mode PPDU or EDMG OFDM mode PPDU.

According to this embodiment, based on a channel receiving a legacy part (e.g., 810˜830 of FIG. 8) of an EDMG SC mode PPDU or EDMG OFDM mode PPDU, a second wireless device may determine one of a first channel pattern or a second channel pattern as a channel bandwidth for the EDMG SC mode PPDU or EDMG OFDM mode PPDU.

For example, first to eighth channels (ch #1˜ch #8) that are mentioned in FIG. 9 may correspond to the first to eighth channels (ch #1˜ch #8) of FIG. 7. For example, the EDMG SC mode PPDU or EDMG OFDM mode PPDU may be understood as the EDMG SC mode PPDU or EDMG OFDM mode PPDU being mentioned in FIG. 8.

According to the embodiment of FIG. 9, information being associated with the channel bandwidth of the PPDU being associated with a specific mode (i.e., the EDMG SC mode PPDU or EDMG OFDM mode PPDU) may be configured of a total of 5 bits.

In this case, the total of 5 bits for the information being associated with the channel bandwidth may correspond to the Compressed BW field, which is included in the PPDU being associated with a specific mode (i.e., the EDMG SC mode PPDU or EDMG OFDM mode PPDU).

According to this embodiment, when a first value (i.e., ‘0’) is set as a value for the channel bandwidth of the EDMG SC mode PPDU or EDMG OFDM mode PPDU, the channel bandwidth being configured based on the first to eighth channels (i.e., ch #1˜ch #8 of FIG. 7) may be understood as a bandwidth of a single channel.

For example, when a first value (i.e., ‘0’) is set as a value for the channel bandwidth of the EDMG SC mode PPDU or EDMG OFDM mode PPDU, as shown below in Table 6, a bandwidth (i.e., 2.16 GHz) of a channel among the first to eighth channels (i.e., ch #1˜ch #8 of FIG. 7) may be indicated.

TABLE 6

| ch#1 | ch#2 | ch#3 | ch#4 | ch#5 | ch#6 | ch#7 | ch#8 |
|---|---|---|---|---|---|---|---|
| x | — | — | — | — | — | — | — |
| — | x | — | — | — | — | — | — |
| — | — | x | — | — | — | — | — |
| — | — | — | x | — | — | — | — |
| — | — | — | — | x | — | — | — |
| — | — | — | — | — | x | — | — |
| — | — | — | — | — | — | x | — |
| — | — | — | — | — | — | — | X |

Herein, ‘x’ of Table 6 may indicate a channel that is being used. And, ‘−’ of Table 6 may indicate a channel that is not being used.

According to this embodiment, when a second value (i.e., ‘1’) is set as a value for the channel bandwidth of the EDMG SC mode PPDU or EDMG OFDM mode PPDU, a channel bandwidth (i.e., 4.32 GHz or 2.16 GHz+2.16 GHz) being configured based on two channels, among the first to eighth channels (i.e., ch #1˜ch #8 of FIG. 7), may be understood as a bandwidth according to the channel bonding scheme or the channel aggregation scheme.

For example, when the second value (i.e., ‘1’) is set as a value for the channel bandwidth of the EDMG SC mode PPDU or EDMG OFDM mode PPDU, as shown below in Table 7, the channel bonding scheme may be applied for two channels among the first to eighth channels (i.e., ch #1˜ch #8 of FIG. 7).

TABLE 7

| ch#1 | ch#2 | ch#3 | ch#4 | ch#5 | ch#6 | ch#7 | ch#8 |
|---|---|---|---|---|---|---|---|
| x | x | — | — | — | — | — | — |
| — | — | x | x | — | — | — | — |
| — | — | — | — | x | x | — | — |
| — | — | — | — | — | — | x | x |

Herein, ‘x’ of Table 7 may indicate a channel that is being used. And, ‘−’ of Table 7 may indicate a channel that is not being used. According to this embodiment, when a third value (i.e., ‘2’) is set as a value for the channel bandwidth of the EDMG SC mode PPDU or EDMG OFDM mode PPDU, a channel bandwidth (i.e., 4.32 GHz or 2.16 GHz+2.16 GHz) being configured based on two channels, among the first to eighth channels (i.e., ch #1˜ch #8 of FIG. 7), may be understood as a bandwidth according to the channel bonding scheme or the channel aggregation scheme.

When the third value (i.e., ‘2’) is set as a value for the channel bandwidth of the EDMG SC mode PPDU or EDMG OFDM mode PPDU, as shown below in Table 8, the channel bonding scheme or channel aggregation scheme may be applied for two channels among the first to eighth channels (i.e., ch #1˜ch #8 of FIG. 7).

TABLE 8

| ch#1 | ch#2 | ch#3 | ch#4 | ch#5 | ch#6 | ch#7 | ch#8 |
|---|---|---|---|---|---|---|---|
| — | x | x | — | — | — | — | — |
| — | — | — | x | x | — | — | — |
| — | — | — | — | — | x | x | — |
| x | — | — | — | — | — | — | x |

Herein, ‘x’ of Table 8 may indicate a channel that is being used. And, ‘−’ of Table 8 may indicate a channel that is not being used.

According to this embodiment, when a fourth value (i.e., ‘3’) is set as a value for the channel bandwidth of the EDMG SC mode PPDU or EDMG OFDM mode PPDU, a channel bandwidth (i.e., 6.48 GHz) being configured based on three channels, among the first to eighth channels (i.e., ch #1˜ch #8 of FIG. 7), may be understood as a bandwidth according to the channel bonding scheme or the channel aggregation scheme.

For example, when the fourth value (i.e., ‘3’) is set as a value for the channel bandwidth of the EDMG SC mode PPDU or EDMG OFDM mode PPDU, as shown below in Table 9, the channel bonding scheme may be applied for three channels among the first to eighth channels (i.e., ch #1˜ch #8 of FIG. 7).

TABLE 9

| ch#1 | ch#2 | ch#3 | ch#4 | ch#5 | ch#6 | ch#7 | ch#8 |
|---|---|---|---|---|---|---|---|
| x | x | x | — | — | — | — | — |
| — | — | — | x | x | x | — | — |

Herein, ‘x’ of Table 9 may indicate a channel that is being used. And, ‘−’ of Table 9 may indicate a channel that is not being used. Referring to Table 9, the fourth value (i.e., ‘3’) may be associated with a first channel pattern being configured of the first to third channels (ch #1˜ch #3) and a second channel pattern being configured of the fourth to sixth channels (ch #4˜ch #6).

According to this embodiment, the second wireless device may receive a legacy part (e.g., 810˜830 of FIG. 8) of an EDMG SC mode PPDU or EDMG OFDM mode PPDU based on a predetermined primary channel.

For example, it may be assumed that the primary channel of the second wireless device is one of the first to third channels (ch #˜ch #3). When the fourth value is indicated through the L-Header (830) of the EDMG SC mode PPDU or EDMG OFDM mode PPDU, the second wireless device may receive the remaining fields (e.g., 840˜890 of FIG. 8) after the L-Header (830) of the EDMG SC mode PPDU or EDMG OFDM mode PPDU based on the first channel pattern.

As another example, it may be assumed that the primary channel of the second wireless device is one of the fourth to sixth channels (ch #4˜ch #6). When the fourth value is indicated through the L-Header (830) of the EDMG SC mode PPDU or EDMG OFDM mode PPDU, the second wireless device may receive the remaining fields after the L-Header (830) of the EDMG SC mode PPDU or EDMG OFDM mode PPDU based on the second channel pattern.

According to this embodiment, when a value for a channel bandwidth associated with the EDMG SC mode PPDU or EDMG OFDM mode PPDU corresponds to multiple channel patterns, the second wireless device may determine one of the multiple channel patterns as its channel bandwidth based on the predetermined primary channel.

According to this embodiment, when a fifth value (i.e., ‘4’) is set as a value for the channel bandwidth of the EDMG SC mode PPDU or EDMG OFDM mode PPDU, the channel bandwidth (i.e., 6.48 GHz) being configured based on three channels, among the first to eighth channels (i.e., ch #1˜ch #8 of FIG. 7), may be understood as a bandwidth according to the channel bonding scheme.

When the fifth value (i.e., ‘4’) is set as a value for the channel bandwidth of the EDMG SC mode PPDU or EDMG OFDM mode PPDU, as shown below in Table 10, the channel bonding scheme may be applied for three channels among the first to eighth channels (i.e., ch #1˜ch #8 of FIG. 7).

TABLE 10

| ch#1 | ch#2 | ch#3 | ch#4 | ch#5 | ch#6 | ch#7 | ch#8 |
|---|---|---|---|---|---|---|---|
| — | x | x | x | — | — | — | — |
| — | — | — | — | x | x | x | — |

Referring to Table 10, the fifth value may be associated with a first channel pattern being configured of the second to fourth channels (ch #2˜ch #4) and a second channel pattern being configured of the fifth to seventh channels (ch #5˜ch #7).

According to this embodiment, when a sixth value (i.e., ‘5’) is set as a value for the channel bandwidth of the EDMG SC mode PPDU or EDMG OFDM mode PPDU, the channel bandwidth (i.e., 6.48 GHz) being configured based on three channels, among the first to eighth channels (i.e., ch #1˜ch #8 of FIG. 7), may be understood as a bandwidth according to the channel bonding scheme.

When the sixth value (i.e., ‘5’) is set as a value for the channel bandwidth of the EDMG SC mode PPDU or EDMG OFDM mode PPDU, as shown below in Table 11, the channel bonding scheme may be applied for three channels among the first to eighth channels (i.e., ch #1˜ch #8 of FIG. 7).

TABLE 11

| ch#1 | ch#2 | ch#3 | ch#4 | ch#5 | ch#6 | ch#7 | ch#8 |
|---|---|---|---|---|---|---|---|
| — | — | x | x | x | — | — | — |
| — | — | — | — | — | x | x | x |

Referring to Table 11, the sixth value may be associated with a first channel pattern being configured of the third to fifth channels (ch #3˜ch #5) and a second channel pattern being configured of the sixth to eighth channels (ch #6˜ch #8). According to this embodiment, when a seventh value (i.e., ‘6’) is set as a value for the channel bandwidth of the EDMG SC mode PPDU or EDMG OFDM mode PPDU, the channel bandwidth (i.e., 8.64 GHz or 4.32 GHz+4.32 GHz) being configured based on four channels, among the first to eighth channels (i.e., ch #1˜ch #8 of FIG. 7), may be understood as a bandwidth applying the channel bonding scheme or as a bandwidth applying both the channel bonding scheme and the channel aggregation scheme.

When the seventh value (i.e., ‘6’) is set as a value for the channel bandwidth of the EDMG SC mode PPDU or EDMG OFDM mode PPDU, as shown below in Table 12, the channel bonding scheme and/or the channel aggregation scheme may be applied for four channels among the first to eighth channels (i.e., ch #1˜ch #8 of FIG. 7).

TABLE 12

| ch #1 | ch #2 | ch #3 | ch #4 | ch #5 | ch #6 | ch #7 | ch #8 |
|---|---|---|---|---|---|---|---|
| x | x | x | x | — | — | — | — |
| — | — | — | — | x | x | x | x |

Referring to Table 12, the seventh value may be associated with a first channel pattern being configured of the first to fourth channels (ch #1˜ch #4) and a second channel pattern being configured of the fifth to eighth channels (ch #5˜ch #8). According to this embodiment, when an eighth value (i.e., ‘7’) is set as a value for the channel bandwidth of the EDMG SC mode PPDU or EDMG OFDM mode PPDU, the channel bandwidth (i.e., 8.64 GHz or 4.32 GHz+4.32 GHz) being configured based on four channels, among the first to eighth channels (i.e., ch #1˜ch #8 of FIG. 7), may be understood as a bandwidth according to the channel bonding scheme and/or the channel aggregation scheme.

When the eighth value (i.e., ‘7’) is set as a value for the channel bandwidth of the EDMG SC mode PPDU or EDMG OFDM mode PPDU, as shown below in Table 13, the channel bonding scheme and/or the channel aggregation scheme may be applied for four channels among the first to eighth channels (i.e., ch #1˜ch #8 of FIG. 7).

TABLE 13

| ch #1 | ch #2 | ch #3 | ch #4 | ch #5 | ch #6 | ch #7 | ch #8 |
|---|---|---|---|---|---|---|---|
| — | x | x | x | x | — | — | — |

Referring to Table 13, the eighth value may be associated with a channel pattern being configured of the second to fifth channels (ch #2˜ch #5). According to this embodiment, when a ninth value (i.e., ‘8’) is set as a value for the channel bandwidth of the EDMG SC mode PPDU or EDMG OFDM mode PPDU, the channel bandwidth (i.e., 8.64 GHz or 4.32 GHz+4.32 GHz) being configured based on four channels, among the first to eighth channels (i.e., ch #1˜ch #8 of FIG. 7), may be understood as a bandwidth applying the channel bonding scheme and/or the channel aggregation scheme.

When the ninth value (i.e., ‘8’) is set as a value for the channel bandwidth of the EDMG SC mode PPDU or EDMG OFDM mode PPDU, as shown below in Table 14, the channel bonding scheme and/or the channel aggregation scheme may be applied for four channels among the first to eighth channels (i.e., ch #1˜ch #8 of FIG. 7).

TABLE 14

| ch #1 | ch #2 | ch #3 | ch #4 | ch #5 | ch #6 | ch #7 | ch #8 |
|---|---|---|---|---|---|---|---|
| — | — | x | x | x | x | — | — |

Referring to Table 14, the ninth value may be associated with a channel pattern being configured of the third to sixth channels (ch #3˜ch #6). According to this embodiment, when a tenth value (i.e., ‘9’) is set as a value for the channel bandwidth of the EDMG SC mode PPDU or EDMG OFDM mode PPDU, the channel bandwidth (i.e., 8.64 GHz or 4.32 GHz+4.32 GHz) being configured based on four channels, among the first to eighth channels (i.e., ch #1˜ch #8 of FIG. 7), may be understood as a bandwidth applying the channel bonding scheme and/or the channel aggregation scheme.

When the tenth value (i.e., ‘9’) is set as a value for the channel bandwidth of the EDMG SC mode PPDU or EDMG OFDM mode PPDU, as shown below in Table 15, the channel bonding scheme and/or the channel aggregation scheme may be applied for four channels among the first to eighth channels (i.e., ch #1˜ch #8 of FIG. 7).

TABLE 15

| ch #1 | ch #2 | ch #3 | ch #4 | ch #5 | ch #6 | ch #7 | ch #8 |
|---|---|---|---|---|---|---|---|
| — | — | — | x | x | x | x | — |

Referring to Table 15, the tenth value may be associated with a channel pattern being configured of the fourth to seventh channels (ch #4˜ch #7). According to this embodiment, when a eleventh value (i.e., ‘10’) is set as a value for the channel bandwidth of the EDMG SC mode PPDU or EDMG OFDM mode PPDU, the channel bandwidth (i.e., 2.16 GHz+2.16 GHz) being configured based on two channels, among the first to eighth channels (i.e., ch #1˜ch #8 of FIG. 7), may be understood as a bandwidth applying the channel aggregation scheme.

When the eleventh value (i.e., ‘10’) is set as a value for the channel bandwidth of the EDMG SC mode PPDU or EDMG OFDM mode PPDU, as shown below in Table 16, the channel aggregation scheme may be applied for two channels among the first to eighth channels (i.e., ch #1˜ch #8 of FIG. 7).

TABLE 16

| ch #1 | ch #2 | ch #3 | ch #4 | ch #5 | ch #6 | ch #7 | ch #8 |
|---|---|---|---|---|---|---|---|
| x | — | x | — | — | — | — | — |
| — | x | — | x | — | — | — | — |
| — | — | — | — | x | — | x | — |
| — | — | — | — | — | x | — | x |

Referring to Table 16, the eleventh value may be associated with a first channel pattern that is configured of the first and third channels (ch #1, ch #3), a second channel pattern that is configured of the second and fourth channels (ch #2, ch #4), a third channel pattern that is configured of the fifth and seventh channels (ch #5, ch #7), and a fourth channel pattern that is configured of the sixth and eighth channels (ch #6, ch #8). For example, based on a channel through which the legacy part of the EDMG SC mode PPDU or EDMG OFDM mode PPDU is transmitted by the first wireless device, the second wireless device may determine one of the first channel pattern to the fourth channel pattern of Table 16 as the channel bandwidth for the EDMG SC mode PPDU or EDMG OFDM mode PPDU.

According to this embodiment, when a twelfth value (i.e., ‘11’) is set as a value for the channel bandwidth of the EDMG SC mode PPDU or EDMG OFDM mode PPDU, the channel bandwidth (i.e., 2.16 GHz+2.16 GHz) being configured based on two channels, among the first to eighth channels (i.e., ch #1˜ch #8 of FIG. 7), may be understood as a bandwidth according to the channel aggregation scheme.

When the twelfth value (i.e., ‘11’) is set as a value for the channel bandwidth of the EDMG SC mode PPDU or EDMG OFDM mode PPDU, as shown below in Table 17, the channel aggregation scheme may be applied for two channels among the first to eighth channels (i.e., ch #1˜ch #8 of FIG. 7).

TABLE 17

| ch #1 | ch #2 | ch #3 | ch #4 | ch #5 | ch #6 | ch #7 | ch #8 |
|---|---|---|---|---|---|---|---|
| — | — | x | — | x | — | — | — |
| — | — | — | x | — | x | — | — |

Referring to Table 17, the twelfth value may be associated with a first channel pattern that is configured of the third and fifth channels (ch #3, ch #5) and a second channel pattern that is configured of the fourth and sixth channels (ch #4, ch #6).

For example, based on a channel through which the legacy part of the EDMG SC mode PPDU or EDMG OFDM mode PPDU is transmitted by the first wireless device, the second wireless device may determine one of the first channel pattern and the second channel pattern of Table 17 as the channel bandwidth for the EDMG SC mode PPDU or EDMG OFDM mode PPDU.

According to this embodiment, when a thirteenth value (i.e., ‘12’) is set as a value for the channel bandwidth of the EDMG SC mode PPDU or EDMG OFDM mode PPDU, the channel bandwidth (i.e., 2.16 GHz+2.16 GHz) being configured based on two channels, among the first to eighth channels (i.e., ch #1˜ch #8 of FIG. 7), may be understood as a bandwidth according to the channel aggregation scheme.

When the thirteenth value (i.e., ‘12’) is set as a value for the channel bandwidth of the EDMG SC mode PPDU or EDMG OFDM mode PPDU, as shown below in Table 18, the channel aggregation scheme may be applied for two channels among the first to eighth channels (i.e., ch #1˜ch #8 of FIG. 7).

TABLE 18

| ch #1 | ch #2 | ch #3 | ch #4 | ch #5 | ch #6 | ch #7 | ch #8 |
|---|---|---|---|---|---|---|---|
| x | — | — | x | — | — | — | — |
| — | x | — | — | x | — | — | — |
| — | — | x | — | — | x | — | — |

Referring to Table 18, the thirteenth value may be associated with a first channel pattern that is configured of the first and fourth channels (ch #1, ch #4), a second channel pattern that is configured of the second and fifth channels (ch #2, ch #5), and a third channel pattern that is configured of the third and sixth channels (ch #3, ch #6). For example, based on a channel through which the legacy part of the EDMG SC mode PPDU or EDMG OFDM mode PPDU is transmitted by the first wireless device, the second wireless device may determine one of the first channel pattern to the third channel pattern of Table 18 as the channel bandwidth for the EDMG SC mode PPDU or EDMG OFDM mode PPDU.

According to this embodiment, when a fourteenth value (i.e., ‘13’) is set as a value for the channel bandwidth of the EDMG SC mode PPDU or EDMG OFDM mode PPDU, the channel bandwidth (i.e., 2.16 GHz+2.16 GHz) being configured based on two channels, among the first to eighth channels (i.e., ch #1˜ch #8 of FIG. 7), may be understood as a bandwidth according to the channel aggregation scheme.

When the fourteenth value (i.e., ‘13’) is set as a value for the channel bandwidth of the EDMG SC mode PPDU or EDMG OFDM mode PPDU, as shown below in Table 19, the channel aggregation scheme may be applied for two channels among the first to eighth channels (i.e., ch #1˜ch #8 of FIG. 7).

TABLE 19

| ch #1 | ch #2 | ch #3 | ch #4 | ch #5 | ch #6 | ch #7 | ch #8 |
|---|---|---|---|---|---|---|---|
| — | — | — | x | — | — | x | — |
| — | — | — | — | x | — | — | x |

Referring to Table 19, the fourteenth value may be associated with a first channel pattern that is configured of the fourth and seventh channels (ch #4, ch #7) and a second channel pattern that is configured of the fifth and eighth channels (ch #5, ch #8). For example, based on a channel through which the legacy part of the EDMG SC mode PPDU or EDMG OFDM mode PPDU is transmitted by the first wireless device, the second wireless device may determine one of the first channel pattern and the second channel pattern of Table 19 as the channel bandwidth for the EDMG SC mode PPDU or EDMG OFDM mode PPDU.

According to this embodiment, when a fifteenth value (i.e., ‘14’) is set as a value for the channel bandwidth of the EDMG SC mode PPDU or EDMG OFDM mode PPDU, the channel bandwidth (i.e., 2.16 GHz+2.16 GHz) being configured based on two channels, among the first to eighth channels (i.e., ch #1˜ch #8 of FIG. 7), may be understood as a bandwidth according to the channel aggregation scheme.

When the fifteenth value (i.e., ‘14’) is set as a value for the channel bandwidth of the EDMG SC mode PPDU or EDMG OFDM mode PPDU, as shown below in Table 20, the channel aggregation scheme may be applied for two channels among the first to eighth channels (i.e., ch #1˜ch #8 of FIG. 7).

TABLE 20

| ch #1 | ch #2 | ch #3 | ch #4 | ch #5 | ch #6 | ch #7 | ch #8 |
|---|---|---|---|---|---|---|---|
| x | — | — | — | x | — | — | — |
| — | x | — | — | — | x | — | — |
| — | — | x | — | — | — | x | — |
| — | — | — | x | — | — | — | x |

Referring to Table 20, the fifteenth value may be associated with a first channel pattern that is configured of the first and fifth channels (ch #1, ch #5), a second channel pattern that is configured of the second and sixth channels (ch #2, ch #6), a third channel pattern that is configured of the third and seventh channels (ch #3, ch #7), and a fourth channel pattern that is configured of the fourth and eighth channels (ch #4, ch #8).

For example, based on a channel through which the legacy part of the EDMG SC mode PPDU or EDMG OFDM mode PPDU is transmitted by the first wireless device, the second wireless device may determine one of the first channel pattern to the fourth channel pattern of Table 20 as the channel bandwidth for the EDMG SC mode PPDU or EDMG OFDM mode PPDU.

According to this embodiment, when a sixteenth value (i.e., ‘15’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the sixteenth value (i.e., ‘15’) is set as a value for the channel bandwidth of the EDMG SC mode PPDU or EDMG OFDM mode PPDU, as shown below in Table 21, the channel bonding scheme and channel aggregation scheme may be applied for four channels among the first to eighth channels (i.e., ch #1˜ch #8 of FIG. 7).

TABLE 21

| ch #1 | ch #2 | ch #3 | ch #4 | ch #5 | ch #6 | ch #7 | ch #8 |
|---|---|---|---|---|---|---|---|
| x | x | — | x | x | — | — | — |

Referring to Table 21, the sixteenth value may be associated with a channel pattern that is configured of the first, second, fourth, and fifth channels (ch #1, ch #2, ch #4, ch #5). According to this embodiment, when a seventeenth value (i.e., ‘16’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the seventeenth value (i.e., ‘16’) is set as a value for the channel bandwidth of the EDMG SC mode PPDU or EDMG OFDM mode PPDU, as shown below in Table 22, the channel bonding scheme and channel aggregation scheme may be applied for four channels among the first to eighth channels (i.e., ch #1˜ch #8 of FIG. 7).

TABLE 22

| ch #1 | ch #2 | ch #3 | ch #4 | ch #5 | ch #6 | ch #7 | ch #8 |
|---|---|---|---|---|---|---|---|
| — | x | x | — | x | x | — | — |

Referring to Table 22, the seventeenth value may be associated with a channel pattern that is configured of the second, third, fifth, and sixth channels (ch #2, ch #3, ch #5, ch #6). According to this embodiment, when an eighteenth value (i.e., ‘17’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the eighteenth value (i.e., ‘17’) is set as a value for the channel bandwidth of the EDMG SC mode PPDU or EDMG OFDM mode PPDU, as shown below in Table 23, the channel bonding scheme and channel aggregation scheme may be applied for four channels among the first to eighth channels (i.e., ch #1˜ch #8 of FIG. 7).

TABLE 23

| ch #1 | ch #2 | ch #3 | ch #4 | ch #5 | ch #6 | ch #7 | ch #8 |
|---|---|---|---|---|---|---|---|
| — | — | x | x | — | x | x | — |

Referring to Table 23, the eighteenth value may be associated with a channel pattern that is configured of the third, fourth, sixth, and seventh channels (ch #3, ch #4, ch #6, ch #7). According to this embodiment, when a nineteenth value (i.e., ‘18’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the nineteenth value (i.e., ‘18’) is set as a value for the channel bandwidth of the EDMG SC mode PPDU or EDMG OFDM mode PPDU, as shown below in Table 24, the channel bonding scheme and channel aggregation scheme may be applied for four channels among the first to eighth channels (i.e., ch #1˜ch #8 of FIG. 7).

TABLE 24

| ch #1 | ch #2 | ch #3 | ch #4 | ch #5 | ch #6 | ch #7 | ch #8 |
|---|---|---|---|---|---|---|---|
| — | — | — | x | x | — | x | x |

Referring to Table 24, the nineteenth value may be associated with a channel pattern that is configured of the third, fourth, sixth, and seventh channels (ch #3, ch #4, ch #6, ch #7).

According to this embodiment, when a twentieth value (i.e., ‘19’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the twentieth value (i.e., ‘19’) is set as a value for the channel bandwidth of the EDMG SC mode PPDU or EDMG OFDM mode PPDU, as shown below in Table 25, the channel bonding scheme and channel aggregation scheme may be applied for four channels among the first to eighth channels (i.e., ch #1˜ch #8 of FIG. 7).

TABLE 25

| ch #1 | ch #2 | ch #3 | ch #4 | ch #5 | ch #6 | ch #7 | ch #8 |
|---|---|---|---|---|---|---|---|
| x | x | — | — | x | x | — | — |
| — | — | x | x | — | — | x | x |

Referring to Table 25, the twentieth value may be associated with a first channel pattern that is configured of the first, second, fifth, and sixth channels (ch #1, ch #2, ch #5, ch #6) and a second channel pattern that is configured of the third, fourth, seventh, and eighth channels (ch #3, ch #4, ch #7, ch #8). For example, based on a channel through which the legacy part of the EDMG SC mode PPDU or EDMG OFDM mode PPDU is transmitted by the first wireless device, the second wireless device may determine one of the first channel pattern and the second channel pattern of Table 25 as the channel bandwidth for the EDMG SC mode PPDU or EDMG OFDM mode PPDU.

According to this embodiment, when a twenty-first value (i.e., ‘20’) is set as a value for the channel bandwidth of the EDMG SC mode PPDU or EDMG OFDM mode PPDU, the channel bandwidth (i.e., 4.32 GHz+4.32 GHz) being configured based on four channels, among the first to eighth channels (i.e., ch #1˜ch #8 of FIG. 7), may be understood as a bandwidth according to the channel bonding scheme and channel aggregation scheme.

When the twenty-first value (i.e., ‘20’) is set as a value for the channel bandwidth of the EDMG SC mode PPDU or EDMG OFDM mode PPDU, as shown below in Table 26, the channel bonding scheme and channel aggregation scheme may be applied for four channels among the first to eighth channels (i.e., ch #1˜ch #8 of FIG. 7).

TABLE 26

| ch #1 | ch #2 | ch #3 | ch #4 | ch #5 | ch #6 | ch #7 | ch #8 |
|---|---|---|---|---|---|---|---|
| — | x | x | — | — | x | x | — |

Referring to Table 26, the twenty-first value may be associated with a channel pattern that is configured of the second, third, sixth, and seventh channels (ch #2, ch #3, ch #6, ch #7). According to the embodiment of FIG. 9, the first to eighth channels (ch #1˜ch #8) may be channels being authorized in advance to the second wireless device through a beacon frame that is periodically transmitted by the first wireless device.

As another example, according to the operation environment of the WLAN system, the first wireless device may not authorize part of the channels, among the first to eighth channels (ch #1˜ch #8), to the second wireless device through the beacon frame.

Additionally, information indicating whether the channel bonding scheme and/or channel aggregation scheme is/are authorized for the second wireless device may be included in the beacon frame, which is periodically transmitted by the first wireless device.

Additionally, information on a primary channel being pre-authorized for the second wireless device may be included in the beacon frame, which is periodically transmitted by the first wireless device.

For example, a non-EDMG portion (e.g., 810˜830 of FIG. 8) of the EDMG SC mode PPDU or EDMG OFDM mode PPDU including information on a channel bandwidth may be transmitted through a single channel.

For example, the non-EDMG portion (e.g., 810˜830 of FIG. 8) of the EDMG SC mode PPDU or EDMG OFDM mode PPDU including information on a channel bandwidth may also be duplicated and transmitted through multiple channels (e.g., ch #1˜ch #8 of FIG. 7).

For example, an EDMG portion (e.g., 840˜890 of FIG. 8) of the EDMG SC mode PPDU or EDMG OFDM mode PPDU may be transmitted based on a channel bandwidth that is signaled in step S910. For example, a primary channel that is predetermined for the second wireless device may be included in the channel bandwidth through which the EDMG portion (e.g., 840˜890 of FIG. 8) of the EDMG SC mode PPDU or EDMG OFDM mode PPDU is transmitted.

In step S920, the first wireless device may transmit a PPDU associated with a specific mode (i.e., EDMG SC mode PPDU or EDMG OFDM mode PPDU) based on the channel bandwidth.

For reference, as described above in step S910, the channel bandwidth according to this embodiment denotes a bandwidth that is signaled to the second wireless device through the Compressed BW field, which is included in the EDMG SC mode PPDU or EDMG OFDM mode PPDU.

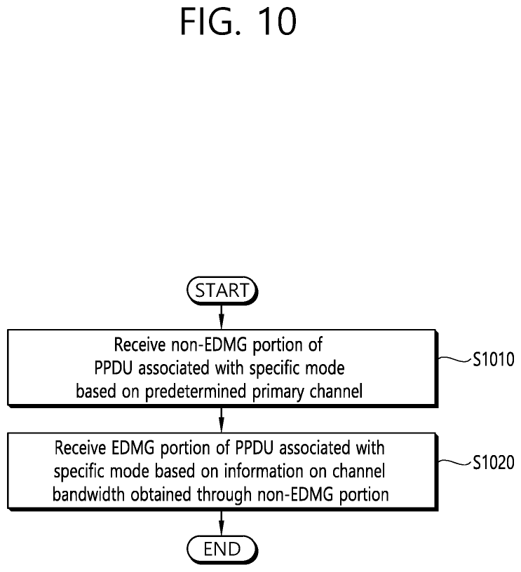

FIG. 10 is a flow chart of a method for receiving a frame based on multiple channels in a wireless LAN system according to an embodiment of this specification.

Referring to FIG. 9 and FIG. 10, in step S1010, the second wireless device may receive the non-EDMG portion (e.g., 810˜830 of FIG. 8) of a PPDU associated with a specific mode (i.e., EDMG SC mode PPDU or EDMG OFDM mode PPDU) from the first wireless device based on a predetermined primary channel.

Herein, the non-EDMG portion (e.g., 810˜830 of FIG. 8) may include channel bandwidth information for the remaining portion (i.e., the EDMG portion (e.g., 840˜890 of FIG. 8)) of the PPDU being associated with a specific mode.

In other words, by decoding the non-EDMG portion (e.g., 810˜830 of FIG. 8), which is received through the predetermined primary channel, the second wireless device may obtain channel bandwidth information for the remaining portion (e.g., 840˜890 of FIG. 8) of the PPDU being associated with a specific mode.

Additionally, in case the channel bandwidth information is associated with multiple channel patterns, the second wireless device may determine, from the multiple channel patterns, a channel bandwidth for the remaining portion (e.g., 840˜890 of FIG. 8) of the PPDU being associated with a specific mode based on the channel bandwidth information and the position of the predetermined primary channel on the frequency.

In step S1020, the second wireless device may receive the remaining portion (e.g., 840˜890 of FIG. 8) of the PPDU being associated with a specific mode based on the channel bandwidth information, which is signaled in step S910.

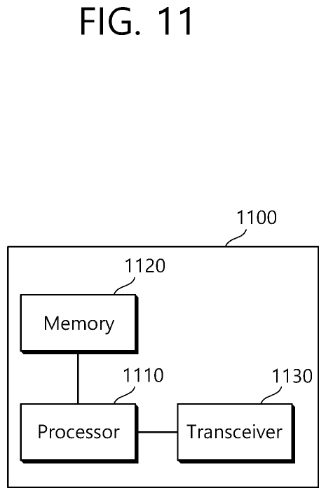

FIG. 11 is a block diagram illustrating a wireless device to which the embodiment may be applied.

Referring to FIG. 11, a wireless device may be an STA that may implement the embodiment described above and operated as an AP or a non-AP STA. In addition, the wireless device may correspond to a user described above or a transmission terminal (or device) that transmits a signal to a user.

The wireless device of FIG. 11 includes a processor (1110), a memory (1120) and a transceiver (1130) as shown in the drawing. The processor (1110), the memory (1120) and the transceiver (1130) may be implemented with a separate chip, or at least two or more blocks/functions may be implemented with a single chip.

The transceiver (1130) is a device including a transmitter and a receiver. In the case that a specific operation is performed, either one operation of the transmitter or receiver may be performed, or both the operations of the transmitter and receiver may be performed.

The transceiver (1130) may include one or more antennas that transmit and/or receive a wireless signal (or radio signal). In addition, the transceiver (1130) may include an amplifier for amplifying a reception signal and/or a transmission signal and a band pass filter for transmitting on a specific frequency band.

The processor (1110) may implement the proposed function, procedure and/or method proposed in the present disclosure. For example, the processor (1110) may perform the operation according to the embodiment described above. That is, the processor (1110) may perform the operation described in the embodiments of FIG. 1 to FIG. 10.

The processor (1110) may include an application-specific integrated circuit (ASIC), other chipset, a logical circuit, a data processing device and/or a transformer that transforms a baseband signal and a wireless signal with each other.

The memory (1120) may include read-only memory (ROM), random access memory (RAM), flash memory, memory card, storage medium and/or other storage device.

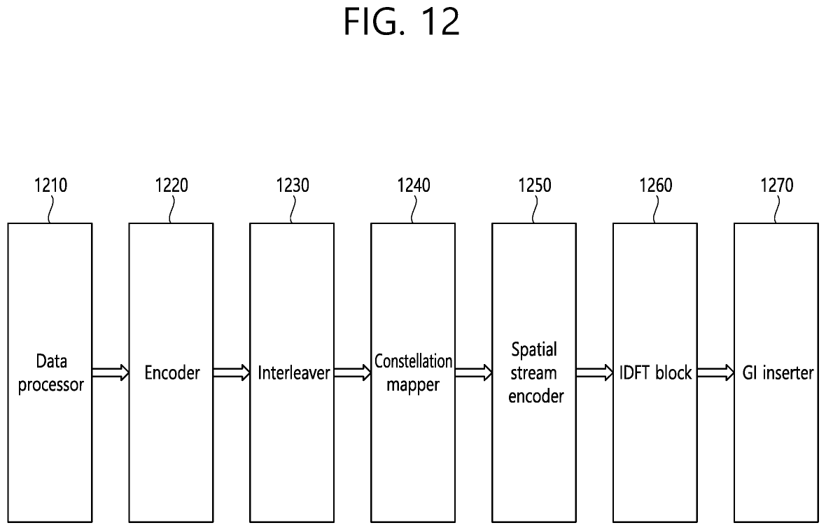

FIG. 12 is a block diagram illustrating an example of a device included in a processor.

For the convenience of description, an example of FIG. 12 is described based on a block for a transmission signal, but it is apparent that a reception signal may be processed using the corresponding block.

A data processor (1210), which is shown, generates transmission data (control data and/or user data) corresponding to a transmission signal. An output of the data processor (1210) may be input to an encoder (1220). The encoder (1220) may perform coding using binary convolutional code (BCC) or low-density parity-check (LDPC) technique. At least one encoder (1220) may be included, and the number of encoders (1220) may be determined by various types of information (e.g., the number of data streams).

An output of the encoder (1220) may be input to an interleaver (1230). The interleaver (1230) performs an operation of distributing consecutive bit signals on a radio resource (e.g., time and/or frequency) to prevent a burst error owing to fading. At least one interleaver (1230) may be included, and the number of interleavers (1230) may be determined by various types of information (e.g., the number of spatial streams).

An output of the interleaver (1230) may be input to a constellation mapper (1240). The constellation mapper (1240) may perform a constellation mapping such as bi-phase shift keying (BPSK), Quadrature Phase Shift Keying (QPSK), n-quadrature amplitude modulation (QAM), and the like.

An output of the constellation mapper (1240) may be input to a spatial stream encoder (1250). The spatial stream encoder (1250) performs a data processing for transmitting a transmission signal through at least one spatial stream. For example, the spatial stream encoder (1250) may perform at least one of space-time block coding (STBC), Cyclic shift diversity (CSD) insertion and spatial mapping.

An output of the spatial stream encoder (1250) may be input to an IDFT (1260). The IDFT (1260) block performs inverse discrete Fourier transform (IDFT) or inverse Fast Fourier transform (IFFT).

An output of the IDFT (1260) is input to a Guard Interval (GI) inserter (1270), and an output of the GI inserter (1270) is input to the transceiver (1130) of FIG. 11.

In the detailed description of the present disclosure, a specific embodiment is described. However, the specific embodiment may be modified in various manners within the scope which is not departing from the scope of the present disclosure. Therefore, the scope of the present disclosure should not be determined limitedly to the embodiment described above but determined by the claims described below and the equivalents of the claims of the present disclosure.

What is claimed is:

1. A method for transmitting a frame based on multiple channels in a wireless LAN system, comprising:
configuring, by a first wireless device, a Physical Protocol Data Unit (PPDU) associated with a specific mode including information on a channel bandwidth based on first to eighth channels, the first to eighth channels being sequentially arranged on a frequency,
wherein the PPDU associated with the specific mode is an Enhanced Directional Multi-Gigabit Single Carrier mode (EDMG SC mode) PPDU or EDMG Orthogonal Frequency Division Multiplexing (OFDM) mode PPDU,
wherein 5 bits are allocated for the information on the channel bandwidth, and
wherein each of the first to eighth channels has a bandwidth of 2.16 GHz; and
transmitting, by the first wireless device, the PPDU associated with the specific mode to a second wireless device based on the channel bandwidth.

2. The method of claim 1, wherein, when a single channel is used for transmitting the PPDU associated with the specific mode, a first value for the first to eighth channels is configured in the information on the channel bandwidth, and
wherein, when a channel bonding scheme or a channel aggregation scheme is used for two channels for transmitting the PPDU associated with the specific mode, a second value being associated with a first channel pattern based on the first channel and the second channel, a second channel pattern based on the third channel and the fourth channel, a third channel pattern based on the fifth channel and the sixth channel, and a fourth channel pattern based on the seventh channel and the eighth channel is configured in the information on the channel bandwidth.

3. The method of claim 1, wherein, when a channel bonding scheme or a channel aggregation scheme is used for two channels for transmitting the PPDU associated with the specific mode, a third value being associated with a first channel pattern based on the second channel and the third channel, a second channel pattern based on the fourth channel and the fifth channel, a third channel pattern based on the sixth channel and the seventh channel, and a fourth channel pattern based on the first channel and the eighth channel is configured in the information on the channel bandwidth, and
wherein, when the channel bonding scheme is used for three channels for transmitting the PPDU associated with the specific mode, a fourth value being associated with a first channel pattern based on the first channel to the third channel and a second channel pattern based on the fourth channel to the sixth channel is configured in the information on the channel bandwidth.

4. The method of claim 1, wherein, when a channel bonding scheme is used for three channels for transmitting the PPDU associated with the specific mode, a fifth value being associated with a first channel pattern based on the second channel to the fourth channel and a second channel pattern based on the fifth channel to the seventh channel is configured in the information on the channel bandwidth, and
wherein, when the channel bonding scheme is used for three channels for transmitting the PPDU associated with the specific mode, a sixth value being associated with a first channel pattern based on the third channel to the fifth channel and a second channel pattern based on the sixth channel to the eighth channel is configured in the information on the channel bandwidth.

5. The method of claim 1, wherein, when only a channel bonding scheme is used or when both the channel boding scheme and the channel aggregation scheme are used for four channels for transmitting the PPDU associated with the specific mode, a seventh value being associated with a first channel pattern based on the first channel to the fourth channel and a second channel pattern based on the fifth channel to the eighth channel is configured in the information on the channel bandwidth, and
wherein, when only the channel bonding scheme is used or when both the channel boding scheme and the channel aggregation scheme are used for four channels for transmitting the PPDU associated with the specific mode, an eighth value being associated with a channel pattern based on the second channel to the fifth channel is configured in the information on the channel bandwidth.

6. The method of claim 1, wherein, when only a channel bonding scheme is used or when both the channel boding scheme and the channel aggregation scheme are used for four channels for transmitting the PPDU associated with the specific mode, a ninth value being associated with a channel pattern based on the third channel to the sixth channel is configured in the information on the channel bandwidth, and
wherein, when only the channel bonding scheme is used or when both the channel boding scheme and the channel aggregation scheme are used for four channels for transmitting the PPDU associated with the specific mode, a tenth value being associated with a channel pattern based on the fourth channel to the seventh channel is configured in the information on the channel bandwidth.

7. The method of claim 1, wherein, when a channel aggregation scheme is used for two channels for transmitting the PPDU associated with the specific mode, an eleventh value being associated with a first channel pattern based on the first channel and the third channel, a second channel pattern based on the second channel and the fourth channel, a third channel pattern based on the fifth channel and the seventh channel, and a fourth channel pattern based on the sixth channel and the eighth channel is configured in the information on the channel bandwidth, and
wherein, when the channel aggregation scheme is used for two channels for transmitting the PPDU associated with the specific mode, a twelfth value being associated with a first channel pattern based on the third channel and the fifth channel and a second channel pattern based on the fourth channel and the sixth channel is configured in the information on the channel bandwidth.

8. The method of claim 1, wherein, when a channel aggregation scheme is used for two channels for transmitting the PPDU associated with the specific mode, a thirteenth value being associated with a first channel pattern based on the first channel and the fourth channel, a second channel pattern based on the second channel and the fifth channel, and a third channel pattern based on the third channel and the sixth channel is configured in the information on the channel bandwidth, and
wherein, when the channel aggregation scheme is used for two channels for transmitting the PPDU associated with the specific mode, a fourteenth value being associated with a first channel pattern based on the fourth channel and the seventh channel and a second channel pattern based on the fifth channel and the eighth channel is configured in the information on the channel bandwidth.

9. The method of claim 1, wherein, when a channel aggregation scheme is used for two channels for transmitting the PPDU associated with the specific mode, a fifteenth value being associated with a first channel pattern based on the first channel and the fifth channel, a second channel pattern based on the second channel and the sixth channel, a third channel pattern based on the third channel and the seventh channel, and a fourth channel pattern based on the fourth channel and the eighth channel is configured in the information on the channel bandwidth, and
wherein, when both the channel boding scheme and channel aggregation scheme are used for four channels for transmitting the PPDU associated with the specific mode, a sixteenth value being associated with a channel pattern based on the first channel, the second channel, the fourth channel, and the fifth channel is configured in the information on the channel bandwidth.

10. The method of claim 1, wherein, when both the channel boding scheme and channel aggregation scheme are used for four channels for transmitting the PPDU associated with the specific mode, a seventeenth value being associated with a channel pattern based on the second channel, the third channel, the fifth channel, and the sixth channel is configured in the information on the channel bandwidth, and
wherein, when both the channel boding scheme and channel aggregation scheme are used for four channels for transmitting the PPDU associated with the specific mode, an eighteenth value being associated with a channel pattern based on the third channel, the fourth channel, the sixth channel, and the seventh channel is configured in the information on the channel bandwidth.

11. The method of claim 1, wherein, when both the channel boding scheme and channel aggregation scheme are used for four channels for transmitting the PPDU associated with the specific mode, a nineteenth value being associated with a channel pattern based on the fourth channel, the fifth channel, the seventh channel, and the eighth channel is configured in the information on the channel bandwidth, and
wherein, when both the channel boding scheme and channel aggregation scheme are used for four channels for transmitting the PPDU associated with the specific mode, a twentieth value being associated with a first channel pattern based on the first channel, the second channel, the fifth channel, and the sixth channel and a second channel pattern based on the third channel, the fourth channel, the seventh channel, and the eighth channel is configured in the information on the channel bandwidth.

12. The method of claim 1, wherein, when both the channel boding scheme and channel aggregation scheme are used for four channels for transmitting the PPDU associated with the specific mode, a twenty-first value being associated with a channel pattern based on the second channel, the third channel, the sixth channel, and the seventh channel is configured in the information on the channel bandwidth.

13. The method of claim 1, wherein the 5 bits are associated with 5 least significant bits (LSBs) of a Length field being included in an L-Header field of the PPDU associated with the specific mode.

14. A first wireless device performing a method for transmitting a frame based on multiple channels in a wireless LAN system, comprising:
a transceiver transmitting and/or receiving radio signals; and
a processor being operatively connected to the transceiver,
wherein the processor is configured to:
configure a Physical Protocol Data Unit (PPDU) associated with a specific mode including information on a channel bandwidth based on first to eighth channels, the first to eighth channels being sequentially arranged on a frequency,
wherein the PPDU associated with the specific mode is an Enhanced Directional Multi-Gigabit Single Carrier mode (EDMG SC mode) PPDU or EDMG Orthogonal Frequency Division Multiplexing (OFDM) mode PPDU,
wherein 5 bits are allocated for the information on the channel bandwidth, and
wherein each of the first to eighth channels has a bandwidth of 2.16 GHz, and
transmit the PPDU associated with the specific mode to a second wireless device based on the channel bandwidth.

15. The wireless device of claim 14, wherein the 5 bits are associated with 5 least significant bits (LSBs) of a Length field being included in an L-Header field of the PPDU associated with the specific mode.
